(19) United States
(12) Patent Application Publication
(10) Pub. No.: US 2018/0321488 A1
(43) Pub. Date: Nov. 8, 2018

(54) PROJECTION TYPE DISPLAY APPARATUS

(71) Applicant: Sharp Kabushiki Kaisha, Sakai City, Osaka (JP)

(72) Inventors: NARU USUKURA, Sakai City (JP); TAKAFUMI SHIMATANI, Sakai City (JP)

(21) Appl. No.: 15/529,357

(22) PCT Filed: Nov. 20, 2015
(86) PCT No.: PCT/JP2015/082734

§ 371 Date: May 24, 2017

(30) Foreign Application Priority Data
Nov. 28, 2014 (JP) 2014-241606

(51) Int. Cl. G02B 27/01; G02B 3/06; G02B 26/08; G02B 26/10

(52) U.S. Cl. CPC G02B 27/0101; G02B 3/06; G02B 2027/0118; G02B 26/101; G02B 26/0833

(57) ABSTRACT

A head-up display 10 includes a projector 11 configured to project an image and having a projector surface 15a, a combiner 12 having a projection surface 12a onto which the image projected by the projector 11 is projected to allow an observer to see a virtual image, the projection surface 12a being tilted relative to the projector surface 15a of the projector 11, a lenticular lens sheet 18 including a plurality of top-displaced cylindrical lenses 25 arranged in a tilting direction tilted relative to the projection surface 12a, the top-displaced cylindrical lenses 25 each including a top 25a displaced such that a brightness peak of projector light is shifted, in relation to a central position in the tilting direction, toward a side where an optical path length of the project light from the projector surface 15a to the projection surface 12a is relatively long.

### TECHNICAL FIELD

The present invention relates to a projection type display apparatus.

### BACKGROUND ART

A head-up display described in Patent Document 1, which is listed below, has been known as an example of a head-up display, which is one type of a projection display apparatus. In the head-up display described in Patent Document 1, a virtual image is displayed by using a liquid crystal display panel and display light emitted by a liquid crystal display unit including a light-emitting device, which is configured to transilluminate the liquid crystal display panel. The liquid crystal display unit includes a condenser lens, which condenses illumination light emitted by the light emitting device, and an optical member including a lenticular lens configured to spread the illumination light condensed by the condenser lens. The lenticular lens has a shape that allows spaces of parallel light rays refracted at integral multiples of a predetermined angle to be smaller or larger by degrees.

### RELATED ART DOCUMENT

### Patent Document

Patent Document 1: Japanese Unexamined Patent Application Publication No. 2010-277065

### Problem to be Solved by the Invention

In general, in the head-up display, the display light emitted by the above-described liquid crystal display unit is projected onto a combiner such that an observer sees a virtual image. A positional relationship between combiner and the liquid crystal display unit may be limited depending on usage of the head-up display. In particular, an in-vehicle head-up display may be required to be mounted in such a manner that the liquid crystal display unit is largely tilted relative to the combiner. In such a case, a brightness distribution in a plane of the combiner may be non-uniform or a portion of light is unlikely to be projected onto the combiner, leading to non-uniform brightness and a reduction in brightness.

### DISCLOSURE OF THE PRESENT INVENTION

The present invention was made based on the above-described circumstances and an object of the present invention is to reduce a deterioration in display quality.

### Means for Solving the Problem

A projection type display apparatus according to the present invention includes a projector configured to project an image and having a projector surface, a projection member having a projection surface onto which the image projected by the projector is projected to allow an observer to see a virtual image, and a lens member included in the projector. The projection surface is tilted relative to the projector surface of the projector. The lens member includes a plurality of top-displaced lenses arranged in a tilting direction tilted relative to the projection surface. The top-displaced lenses each include a top displaced such that a brightness peak of projector light to be projected onto the projection surface is shifted, in relation to a central position in the tilting direction, toward a side where an optical path length of the projector light from the projector surface to the projection surface is relatively long.

With this configuration, the light from the projector, which is configured to project an image, is projected by the projection member and an observer sees the light as a virtual image. Since the projection member is arranged such that the projection surface is tilted relative to the projector surface of the projector, the brightness distribution in the plane of the projection surface may be non-uniform or a portion of light is unlikely to be projected onto the projection surface. To solve the problem, the lens member included in the projector includes the plurality of top-displaced lenses arranged in the tilting direction. The top-displaced lenses each have the top displaced such that the brightness peak of the projector light is shifted, relation to the central position in the tilting direction, toward the side where the optical path length of the projector light from the projector surface to the projection surface is relatively long. This compensates for lack of brightness at the side where the optical path length from the top-displaced lens is long and reduces the brightness, which may be too high at the side where the optical path length is short, making the brightness distribution in the plane of the projection surface of the projection member uniform. Furthermore, this configuration reduces the amount of light not projected onto the projection surface of the projection member, improving the light use efficiency and thus improving the brightness of the projection surface.

The following configurations are preferred embodiments of the present invention.
(1) In the lens member, the top-displaced lenses each have different curvatures at portions on opposite sides of the top. The portion from which the projector light is projected toward a side where the optical path length is relatively long, in relation to the central position in the tilting direction, has a relatively small curvature and the portion from which the projector light is projected toward a side where the optical path length is relatively short, in relation to the central position in the tilting direction, has a relatively large curvature. In the top-displaced lens, the amount of light to be projected onto the projection surface of the projection member tends to increase and a projection area of the projection surface tends to decrease as the curvature decreases, and the amount of light to be projected onto the projection surface of the projection member tends to decrease and the projection area of the projection surface tends to increase as the curvature increases. Thus, the brightness distribution in the projection surface of the projection member is made more uniform and the amount of light not projected onto the projection surface is reduced by the top-displaced lens having the different curvatures at the portions on opposite sides of the top in which the portion from which the projector light is projected toward the side where the optical path length is relatively long, in relation to the central position in the tilting direction, has a relatively small curvature, and the portion from which the projector light is projected toward the side where the optical path length is relatively short, in relation to the central position in the tilting direction, has a relatively large curvature.

(2) In the lens member, the portion of each of the top-displaced lenses from which the projector light is projected toward the side where the optical path length is relatively short, in relation to the central position in the tilting direction, has a curvature gradually increasing with distance from the top in the tilting direction. In this configuration, the portion of the top-displaced lens at the side from which the projector light is projected toward the side where the optical path length is relatively short, in relation to the central position in the tilting direction, has an aspherical surface, since the curvature gradually increases with distance from the top in the tilting direction. This more reliably reduces the brightness in the plane of the projection surface of the projection member, which may be too high at the side where the optical path length from the top-displaced lens is short, and thus more reliably makes the brightness distribution more uniform.

(3) In the lens member, the top-displaced lenses each have a convex shape, and the top is displaced toward an end at a side where the optical path length is relatively short, which is one of ends in the tilting direction. In this configuration, the brightness peak of the projector light from the top-displaced lens having a convex shape is shifted, in relation to the central position in the tiling direction, toward the side where the optical path length of the projector light from the projector surface to the projection surface is relatively long. This compensates for lack of brightness at the side where the optical path length from the top-displaced lens having the convex shape is long and reduces the brightness, which may be too high at the side where the optical path length is short, making the brightness distribution in the plane of the projection surface of the projection member uniform. In addition, this configuration reduces the amount of light not projected onto the projection surface of the projection member, improving the light use efficiency and thus improving the brightness of the projection surface.

(4) In the lens member, the top-displaced lenses each have a concave shape, and the top is displaced toward an end at a side where the optical path length is relatively short, which is one of ends in the tilting direction. In this configuration, the brightness peak of the protector light from the top-displaced lens having a concave shape is shifted, in relation to the central position in the tilting direction, toward the side where the optical path length of the projector light from the projector surface to the projection surface is relatively long. This compensates for lack of brightness at the side where the optical path length from the top-displaced lens having a concave shape is long and reduces the brightness, which may be too high at the side where the optical path length is short, making the brightness distribution in the plane of the projection surface of the projection member uniform. In addition, the amount of light not projected onto the projection surface of the projection member is reduced, improving the light use efficiency and thus improving the brightness of the projection surface.

(5) The lens member at least includes a first lenticular lens portion including a plurality of top-displaced cylindrical lenses, as the plurality of top-displaced lenses, extending along the projector surface in a direction intersecting the tilting direction and a second lenticular lens portion including a plurality of top-centered cylindrical lenses extending in the tilting direction and arranged along the projector surface in a direction perpendicular to the tilting direction. The top-centered cylindrical lenses each have a top at a central position in the tilting direction. In this configuration, since the plurality of top-displaced cylindrical lenses included in the first lenticular lens portion and the plurality of top-centered cylindrical lenses included in the second lenticular lens portion intersect each other, an application area of the projector light projected onto the projection member has a rectangular shape. This also allows an application area of the projection light projected by the projection member to have a rectangular shape, enabling the light to be efficiently collected within the visible range (eye box) of an observer and thus providing high light use efficiency, for example.

(6) In the lens member, an extending direction of the plurality of top-displaced cylindrical lenses and an extending direction of the plurality of top-centered cylindrical lenses are perpendicular to each other. In this configuration, the application area of the projector light projected from the lens member onto the projection member and the application area of the projection light projected by the projection member have a more preferable rectangular shape, allowing the light to be efficiently collected within the visible range (eye box) of an observer. This provides high light use efficiency, for example.

(7) The lens member includes a base having a first planar surface on which the first lenticular lens portion is disposed and a second planar surface on which the second lenticular lens portion is disposed. In this configuration, in contrast to the case where the both lenticular lens portions are disposed on one of the planar surfaces of the base, the entire area of each planar surface of the base is used as a formation area of corresponding lenticular lens.

(8) The lens member at least includes an anisotropic microlens array from which anisotropic exiting light exits. The anisotropic microlens array includes a plurality of top-displaced microlenses, as the plurality of top-displaced lenses, arranged in the tilting direction and in a direction intersecting the tilting direction in a plane of the projector surface. The top-displaced microlenses each have a quadrilateral planar shape. In this configuration, since the top-displaced microlens included in the anisotropic microlens array has a quadrilateral planar shape, light exiting from the top-displaced microlens is anisotropic. This allows the application area of the projector light projected onto the projection member to have a rectangular shape. This also allows the application area of the projection light projected by the projection member to have a rectangular shape, enabling the light to be efficiently collected within the visible range (eye box) of an observer and thus providing high light use efficiency, for example.

(9) The projector at least includes the lens member, a MEMS mirror device at least including a mirror configured to reflect light and a mirror driver configured to drive the mirror such that the lens member is scanned by light reflected by the mirror, and a light source configured to provide light to the MEMS mirror device. In this configuration, the light from the light source is reflected by the mirror included in the MEMS mirror device. Since the mirror is driven by the mirror driver, the light reflected by the driven mirror scans the lens member. In addition, since the lens member includes the top-displaced lenses, the brightness distribution in the plane of the projection surface of the projection member onto which the light from the lens member is projected is reliably made uniform and the light use efficiency is improved.

(10) The projector at least includes a display panel and a lighting apparatus configured to apply light to the display panel. The lighting apparatus at least includes the lens member and a light source configured to apply light to the lens member. In this configuration, the light from the light source is applied to the display panel after an optical effect is applied to the light by the lens member. The light from the display panel is projected onto the projection member and projected by the projection member, enabling an observer to see the light as a virtual image. Since the lighting apparatus configured to apply light to the display panel includes the lens member including the top-displaced lenses, the brightness distribution in the plane of the projection surface of the projection member, onto which the light from the display panel is projected, is reliably made uniform and the light use efficiency is improved.

(11) The projector includes an isotropic microlens array from which isotropic exiting light exits. The isotropic microlens array is located farther than the lens member from the projection member and includes top-centered microlenses arranged in the tilting direction and in a direction intersecting the tilting direction in a plane of the projector surface. The top-centered microlenses each have a polygonal shape with five or more sides or a circular planar shape and have a top at a central position in the tilting direction. In this configuration, the isotropic exiting light from the isotropic microlens array including the top-centered microlenses is projected onto the projection member through the lens member. The isotropic microlens array having such a configuration reliably reduces speckle.

(12) The projector includes a field lens located closer than the lens member to the projection member. In this configuration, the light from the lens member is projected onto the projection member through the field lens. The traveling direction of the light is regulated by the field lens, reducing the amount of light not projected onto the projection surface of the projection member and thus improving the light use efficiency.

### Advantageous Effect of the Invention

The present invention reduces a deterioration in display quality.

### BRIEF DESCRIPTION OF THE DRAWINGS

FIG. 1 is a side view illustrating a schematic configuration of a head-up display according to a first embodiment of the present invention mounted in an automobile.

FIG. 2 is a side view illustrating a positional relationship between a combiner and projector, which are included in the head-up display.

FIG. 3 is a cross-sectional view illustrating a cross-sectional configuration of a screen included in the projector.

FIG. 4 is a cross-sectional view taken along line iv-iv in FIG. 3.

FIG. 5 is a plan view of an isotropic microlens sheet included in the screen.

FIG. 6 is a plan view of a lenticular lens sheet included in the screen.

FIG. 7 is a bottom view of the lenticular lens sheet included in the screen.

FIG. 8 is a cross-sectional view illustrating a detailed cross-sectional configuration of the lenticular lens sheet.

FIG. 9 is a graph indicating a surface shape of a top-displaced cylindrical lens.

FIG. 10 is a graph indicating a brightness distribution of exiting light from the top-displaced cylindrical lens.

FIG. 11 is a graph indicating a brightness distribution of an image projected onto a projection surface of the combiner.

FIG. 12 is a cross-sectional view illustrating a cross-sectional configuration of a screen according to a second embodiment of the present invention.

FIG. 13 is a cross-sectional view illustrating a cross-sectional configuration of a screen according to a third embodiment of the present invention.

FIG. 14 is a cross-sectional view taken along line xiv-xiv in FIG. 13.

FIG. 15 is a bottom view of a lenticular lens sheet included in the screen.

FIG. 16 is a cross-sectional view illustrating a cross-sectional configuration of a screen according to a fourth embodiment of the present invention.

FIG. 17 is a cross-sectional view illustrating a cross-sectional configuration of a screen according to a fifth embodiment of the present invention.

FIG. 18 is a cross-sectional view taken along line xviii-xviii in FIG. 17.

FIG. 19 is a cross-sectional view illustrating a detailed cross-sectional configuration of the lenticular lens sheet.

FIG. 20 is a side view illustrating a projector according to a sixth embodiment of the present invention.

FIG. 21 is a cross-sectional view illustrating a cross-sectional configuration of a liquid crystal display unit included in the projector.

FIG. 22 is a side view illustrating a projector according to a seventh embodiment of the present invention.

FIG. 23 is a cross-sectional view illustrating a cross-sectional configuration of a screen according to an eighth embodiment of the present invention.

FIG. 24 is a cross-sectional view taken along line xxiv-xxiv in FIG. 23.

FIG. 25 is a plan view of an anisotropic microlens sheet included in the screen.

### MODE FOR CARRYING OUT THE INVENTION

### First Embodiment

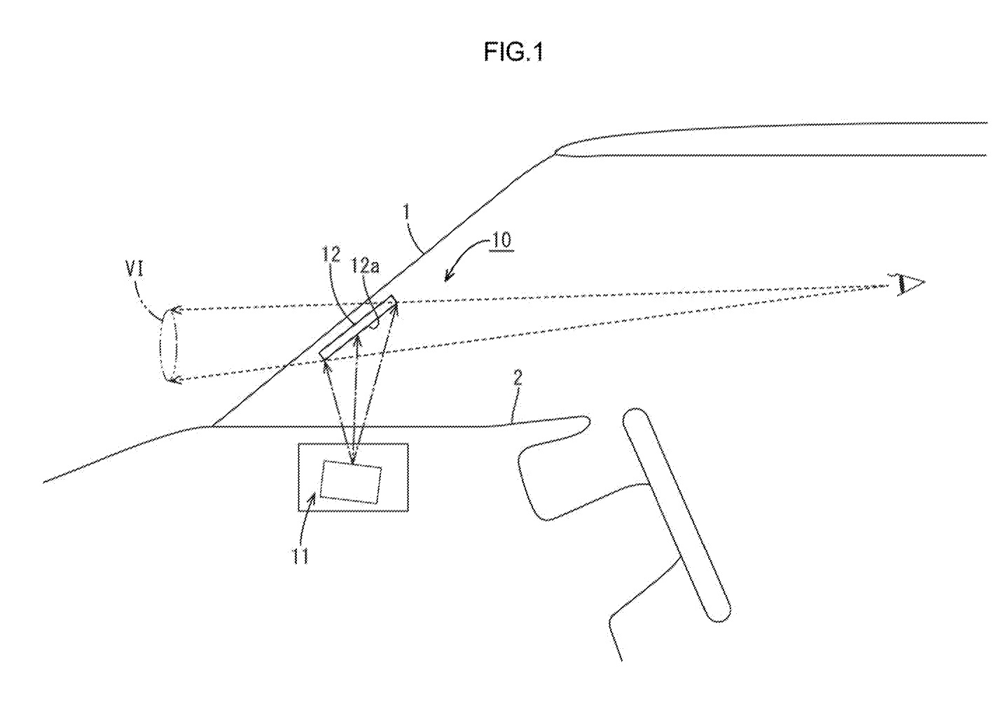

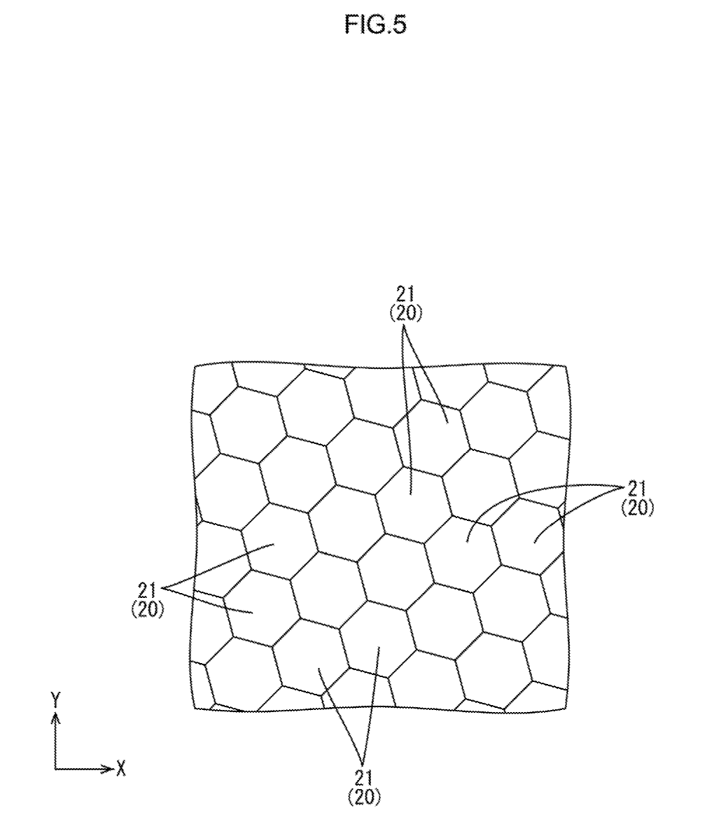

A first embodiment of the present invention is described with reference to FIG. 1 to FIG. 11. In this embodiment, a head-up display (projection type display apparatus) 10 to be mounted in an automobile is described as an example. The head-up display 10 is configured to display a virtual image VI including various information, such as an operating speed, various warnings, and map information, in front of a driver through a front window 1 during driving. This reduces movement of the driver's eye during driving.

As illustrated in FIG. 1, the head-up display 10 includes a projector 11, which is located in a dashboard 2 and is configured to project an image, and a combiner (projection member) 12, which faces the front window 1 and onto which the image projected by the projector 11 is projected in such a manner that an observer, such as a driver, sees a virtual image VI. The combiner 12 is arranged in parallel with the front window 1, which is tilted backward relative to the vertical direction (backward tilting positioning). The projector 11 located in the dashboard 2 forms an elevation angle with the combiner 12.

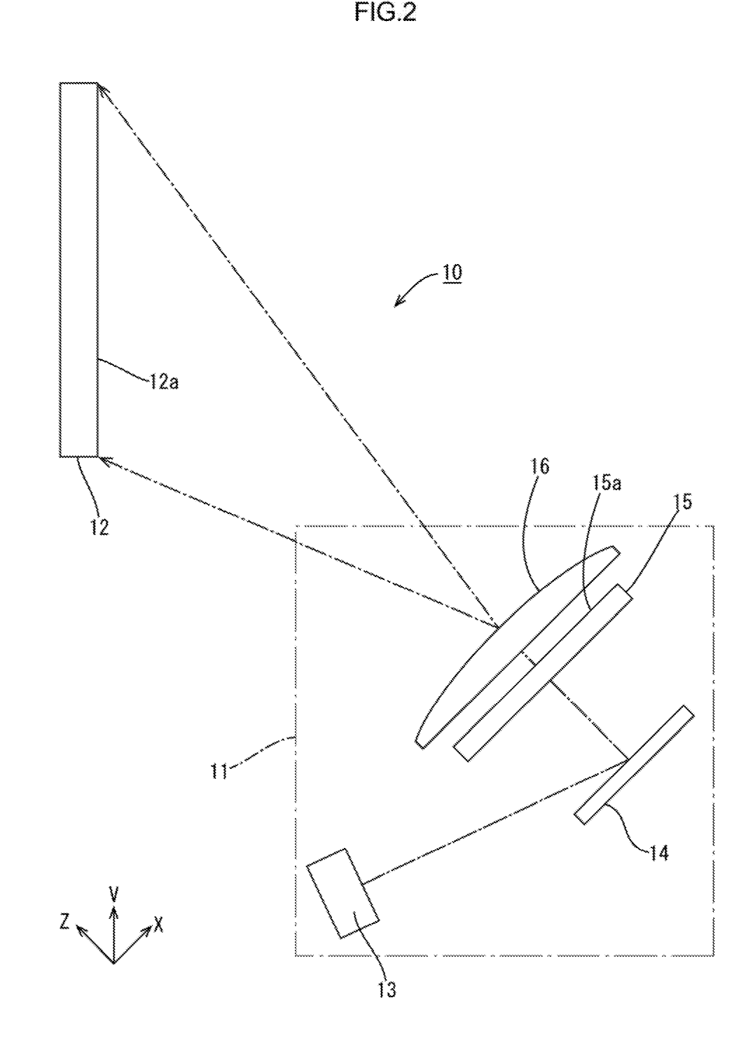

As illustrated in FIG. 2, the projector 11 includes a laser diode (light source) 13, a MEMS mirror device (display device) 14, which is configured to display an image by using light from the laser diode 13, a screen 15, onto which an image displayed on the MEMS mirror device 14 is projected with the image being magnified, and a field lens 16, which is configured to project the light from the screen 15 onto the combiner 12. The term “MEMS” used herein refers to “Micro Electro Mechanical Systems”. In FIG. 2, the head-up display 10 is illustrated such that the vertical direction in FIG. 2 corresponds to the vertical direction (a direction perpendicular to the horizontal direction) of the combiner 12.

As illustrated in FIG. 1, the combiner 12 is located slightly inward from the front window 1 and is attached to, for example, a supporting member on the dashboard 2 or a sun visor (both are not illustrated), such that the position is fixed. The combiner 12 has a projection surface 12a onto which an image from the projector 11 is projected and has a horizontally elongated rectangular shape (quadrilateral shape) corresponding to a visible range (eye box) of an observer, such as a driver. The term “horizontally elongated rectangular shape” herein refers to a rectangular shape whose longitudinal direction (lateral direction) corresponds to the horizontal direction and whose width direction (vertical direction) corresponds to a direction perpendicular to the horizontal direction. Since two pupils (eyes) of the observer are adjacent to each other in the horizontal direction, the visible range of the observer has a horizontally elongated rectangular shape. The combiner 12 includes a red light reflective portion configured to mainly selectively reflect red light, a green light reflective portion configured to mainly selectively reflect green light, and a blue light reflective portion configured to mainly selectively reflect blue light. The red, green, and blue light reflective portions are laminated and each fixed to adjacent one of the portions with a fastening layer formed of an adhesive or the like. The light reflective portions included in the combiner 12 each include a cholesteric liquid, crystal panel. The cholesteric liquid crystal panel includes a cholesteric liquid crystal layer having a periodic structure in which liquid crystal molecules undergo a helical twist in a predetermined period. This enables the cholesteric liquid crystal panel to selectively reflect light having a predetermined wavelength corresponding to the pitch of the twist of the liquid crystal molecules. As can be understood from this, the combiner 12 is a reflective member having wavelength selectivity and allows outside light, which does not match the reflectance spectrum of each light reflective portion, to pass therethrough. Thus, the combiner 12 causes the light reflected by the light reflective portions to be projected onto pupils of an observer, enabling the observer to see a virtual image VI, which is projected by using the reflected light, with high brightness, and to see an outside view in front of the front window 1, which is visible by outside light passed through the combiner 12 with high transmission. The combiner 12 has outside light (outside visible light) transmission of at least 70% or more, which satisfies the Japanese Safety Regulations for Road Vehicles.

The laser diode 13 illustrated in FIG. 2 includes a red laser diode device configured to emit red light having a wavelength in a wavelength range of red (about 600 nm to about 780 nm), a green laser diode device configured to emit green light having a wavelength in a wavelength range of green (about 500 nm to about 570 nm), and a blue laser diode device configured to emit blue light having a wavelength in a wavelength range of blue (about 420 nm to about 500 nm). The laser diode devices of the above-described colors included in the laser diode 13 each include a resonator configured to multireflect light for oscillation. The light from each diode device is a beam of coherent light having light waves of the same frequency with a constant phase difference and the light is linearly polarized. The laser diode 13 is configured to emit red green light, and blue light in a predetermined order and timing. In the laser diode 13, the emission intensity of each of the red, green, and blue light is adjusted such that an image displayed by the light has a predetermined white balance. The laser diode devices of the above-described colors, which are light sources, are not illustrated.

The MEMS mirror device 14 illustrated in FIG. 2 includes a single mirror and a driver (mirror driver) configured to drive the mirror, which are formed on a board with a MEMS technology. The mirror has a circular shape having a diameter in a range of a few tenths of a millimeter to a few millimeters, for example, and has a reflection surface, which is a mirror surface, configured to reflect the light from the laser diode 13. The driver supports the mirror with two shafts perpendicular to each other and tilts the mirror with an electromagnetic force or an electrostatic force in any direction. In the MEMS mirror device 14, the tilting of the mirror is controlled by the driver such that light exits toward the screen 15 and two-dimensionally scans the screen 15. This enables a two-dimensional image to be projected onto the screen 15. A polarization convertor (not illustrated), which is configured to convert the linearly polarized light from the laser diode 13 into left or right circularly polarized light, is preferably disposed between the MEMS mirror device 14 and the laser diode 13. The polarization convertor includes a retardation plate (quarter wavelength retardation plate) configured to cause a phase difference of a quarter wavelength, for example.

As illustrated in FIG. 2, the field lens 16 includes a convex lens larger than the screen 15, and the field lens 16 is located closer than the screen 15 to the combiner 12 (side opposite the MEMS mirror device 14). The filed lens 16 regulates the traveling direction of the light from the screen 15 such that the light is efficiently projected onto the projection surface 12a of the combiner 12. This reduces the light that is not projected onto the projection surface 12a of the combiner 12 and thus improves the light use efficiency.

As illustrated in FIG. 2, the screen 15 is configured to allow the light from the MEMS mirror device 14 to be projected thereon and allow the projected image to be projected onto the combiner 12 through the field lens 16. The screen 15 includes projector surface (light exiting surface) 15a from which the image is projected onto the combiner 12. The screen 15 is positioned such that the projector surface 15a is tilted relative to the projection surface 12a of the combiner 12. Hereinafter, the tilting direction relative to the projection surface 12a is referred to as the X-axis direction, a direction extending along the projector surface 15a and perpendicular to the tilting direction is referred to as the Y-axis direction, and a normal direction of the projector surface 15a is referred to as the Z-axis direction. These directions are indicated in FIG. 2 to FIG. 8. Furthermore, hereinafter, the vertical direction of the combiner 12 is referred to as the V-axis direction, and the V-axis direction is indicated in FIG. 2 to FIG. 4 and FIG. 8. The optical path length of the projector light from the projector surface 15a of the screen 15 to the projection surface 12a of the combiner 12 is the longest at an upper side of the projection surface 12a in the V-axis direction (vertical direction), i.e., at a first end 12b located farthest from the screen 15 in the V-axis direction and is the shortest at a lower side in the V-axis direction, i.e., a second end 12c closest to the screen 15 in the V-axis direction. Therefore, in the plane of the projector surface 15a of the screen 15, a right side in the X-axis direction (titling direction) in FIG. 2 is a side where the optical path length of the projector light is short and a left side in FIG. 2 is a side where the optical path length of the projector light is long. In a similar way, in the plane of the projection surface 12a of the combiner 12, an upper side in the V-axis direction (side adjacent o the first end 12b) in FIG. 2 is a side where the optical path length of the projector light is long and a lower side in FIG. 2 (side adjacent to the second end 12c) is a side where the optical path length of the projector light is short. The incident angle of the projector light onto the projection surface 12a of the combiner 12 is the smallest at the lower end of the projection surface 12a in the V-axis direction and the largest at the upper end of the projection surface 12a in the V-axis direction. Thus, in the plane of the projector surface 15a of the screen 15, the right side in the X-axis direction in FIG. 2 is a side where the incident angle of the projector light is small and the left side in FIG. 2 is a side where the incident angle of the projector light is large. In a similar way, in the plane of the projection surface 12a of the combiner 12, the upper side in FIG. 2 in the V-axis direction (side adjacent to the first end 12b) is a side where the incident angle of the projector light is large and the lower side in FIG. 2 (side adjacent to the second end 12c) is a side where the incident angle of the projector light is small.

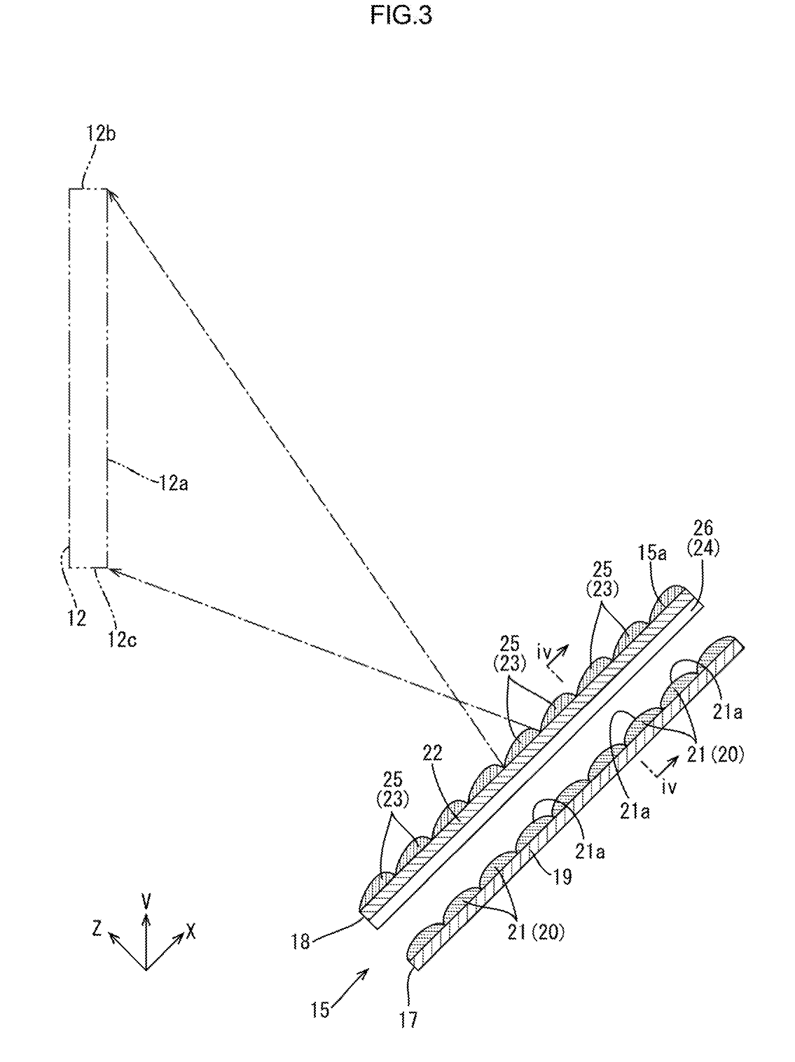

The screen 15 functions as a secondary light source and gives an optical effect to the light from the MEMS mirror device 14 such that an application area of the light applied to the projection surface 12a of the combiner 12 has a horizontally elongated rectangular shape. To exhibit the optical function, as illustrated in FIG. 3, the screen 15 includes an isotropic microlens sheet (isotropic lens member) 17 and a lenticular lens sheet (lens member, anisotropic lens member) 18. In the screen 15, planar surfaces of the isotropic microlens sheet 17 and the lenticular lens sheet 18 face each other with a predetermined space therebetween. Hereinafter, configurations of the isotropic microlens sheet 17 and the lenticular lens sheet 18 are described in detail.

As illustrated in FIG. 3 to FIG. 5, the isotropic microlens sheet 17 includes a sheet base 19 and an isotropic microlens array 20 disposed on a planar surface of the sheet base 19. The isotropic microlens array 20 is disposed on one of planar surfaces of the sheet base 19 that faces the lenticular lens sheet 18. The isotropic microlens array 20 includes a plurality of top-centered microlenses 21 arranged in the X-axis direction and the Y-axis direction on the planar surface of the sheet base 19. The top-centered microlens 21 is a convex microlens and has a substantially hexagonal planar shape. The top-centered microlenses 21 are in a modified hexagonal close-packed arrangement on the planar surface of the sheet base 19. With this configuration, the top-centered microlens 21 provides light from the MEMS minor device 14 with an isotropic light focusing properties before the light exits therefrom, and thus the exiting light is isotropic. The top-centered microlens 21 has a substantially semispherical surface (lens surface) and a top 21a thereof is located at the substantially central position in the X-axis direction and the Y-axis direction. In other words, the top 21a of the top-centered microlens 21 is not displaced in the X-axis direction and the Y-axis direction. The isotropic microlens sheet 17 having such a configuration reduces speckle, which may occur when the laser diode 13 is used as a light source, and thus improves the display quality.

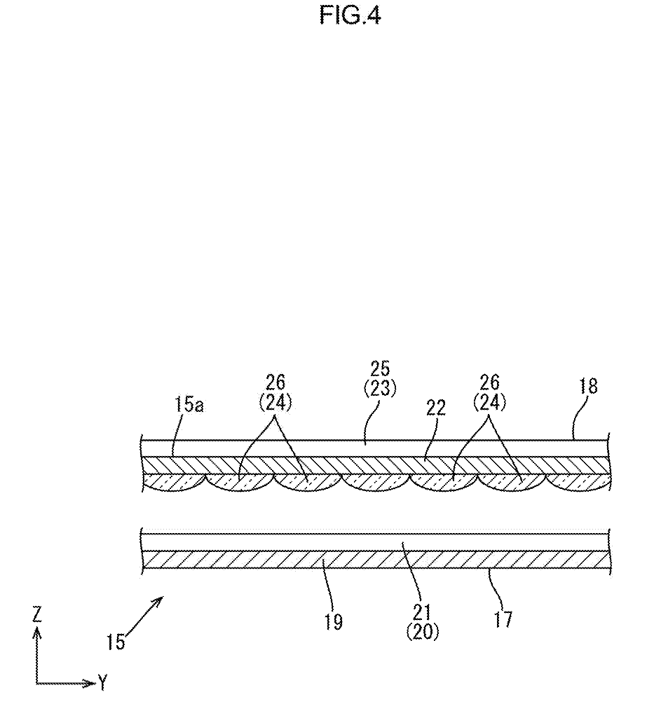

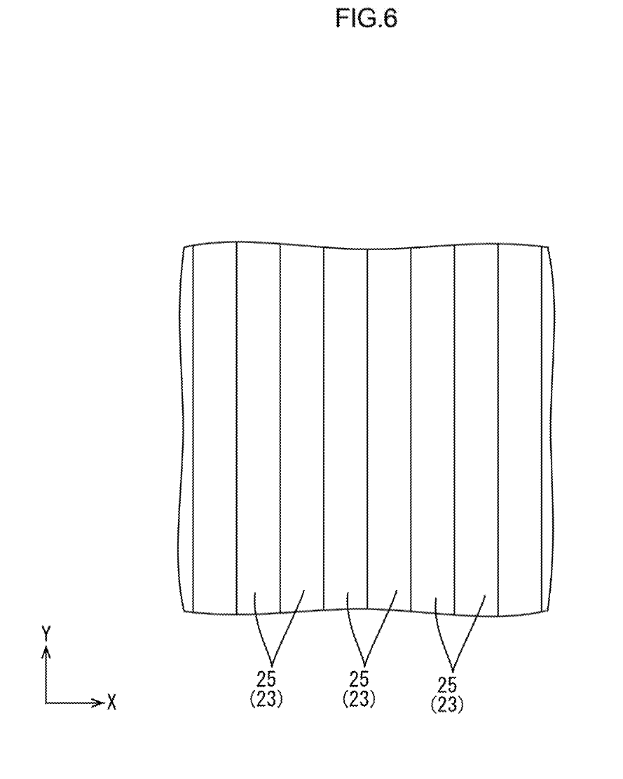

As illustrated in FIG. 3 and FIG. 4, the lenticular lens sheet 18 includes a sheet base 22, a first lenticular lens portion 23 on a first planar surface of the sleet base 22, i.e., on a planar surface of the sheet base 22 adjacent to the combiner 12, and a second lenticular lens portion 24 on a second planar surface of the sheet base 22, i.e., on a planar surface of the sheet base 22 adjacent to the isotropic microlens sheet 17 (side opposite the combiner 12). As illustrated in FIG. 3 and FIG. 6, the first lenticular lens portion 23 includes a plurality of convex top-displaced cylindrical lenses (top-displaced lenses) 25 each having a substantially semicylindrical shape. On the first planar surface of the sheet base 22, the top-displaced cylindrical lenses 25 each extend in the Y-axis direction and are arranged adjacent to each other in the X-axis direction (tilting direction). Thus, a condensing direction of the first lenticular lens portion 23 corresponds to the X-axis direction, which is the arrangement direction of the top-displaced cylindrical lenses 25, and a non-condensing direction of the first lenticular lens portion 23 corresponds to the Y-axis direction, which is the extending direction of the top-displaced cylindrical lenses 25. The top-displaced cylindrical lenses 25 are arranged adjacent to each other in the X-axis direction, which is the arrangement direction of the top-displaced cylindrical lenses 25, with almost no space therebetween (no gap). The top-displaced cylindrical lenses 25 are disposed over the entire area of the planar surface of the sheet base 22 of the lenticular lens sheet 18.

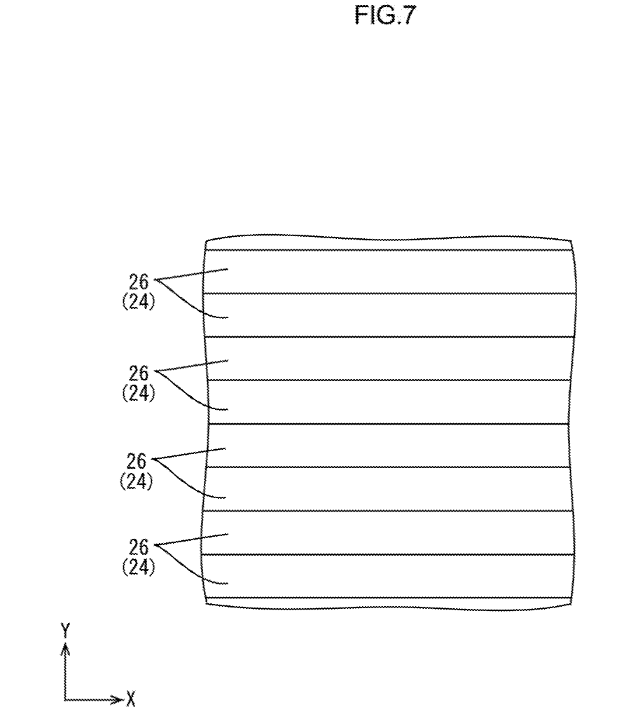

As illustrated in FIG. 4 and FIG. 7, the second lenticular lens portion 24 includes a plurality of convex top-centered cylindrical lenses 26 each having a substantially semicylindrical shape. On the second planar surface of the sheet base 22, the top-centered cylindrical lenses 26 each extend in the X-axis direction and are arranged adjacent to each other in the Y-axis direction. Thus, a condensing direction of the second lenticular lens portion 24 corresponds to the Y-axis direction, which is the arrangement direction of the top-centered cylindrical lenses 26, and a non-condensing direction of the second lenticular lens portion 24 corresponds to the X-axis direction, which is the extending direction of the top-centered cylindrical lenses 26. The top-centered cylindrical lenses 26 are arranged adjacent to each other in the Y-axis direction, which is the arrangement direction of the top-centered cylindrical lenses 26, with almost no space therebetween. The top-centered cylindrical lenses 26 are disposed over the entire area of the planar surface of the sheet base 22 of the lenticular lens sheet 18.

As described above, the extending directions (arrangement directions) of the top-displaced cylindrical lenses 25 included in the first lenticular lens portion 23 and the top-centered cylindrical lenses 26 included in the second lenticular lens portion 24 are perpendicular to each other, as illustrated in FIG. 3 and FIG. 4, and the condensing directions (non-condensing direction) thereof are also perpendicular to each other. Thus, the application area of the projector light, which exists from the lenticular lens sheet 18 and projects onto the projection surface 12a of the combiner 12, has a substantially rectangular shape. The application area of the projector light to be projected onto the projection surface 12a of the combiner 12 is controlled by proper adjustment of the lens width or the lens pitch of the cylindrical lenses 25, 26, for example. This allows the application area of the projector light to have a horizontally elongated rectangular shape, which corresponds to the visible range (eye box) of the observer, enabling the light to be efficiently collected within the visible range of the observer and thus providing high light use efficiency.

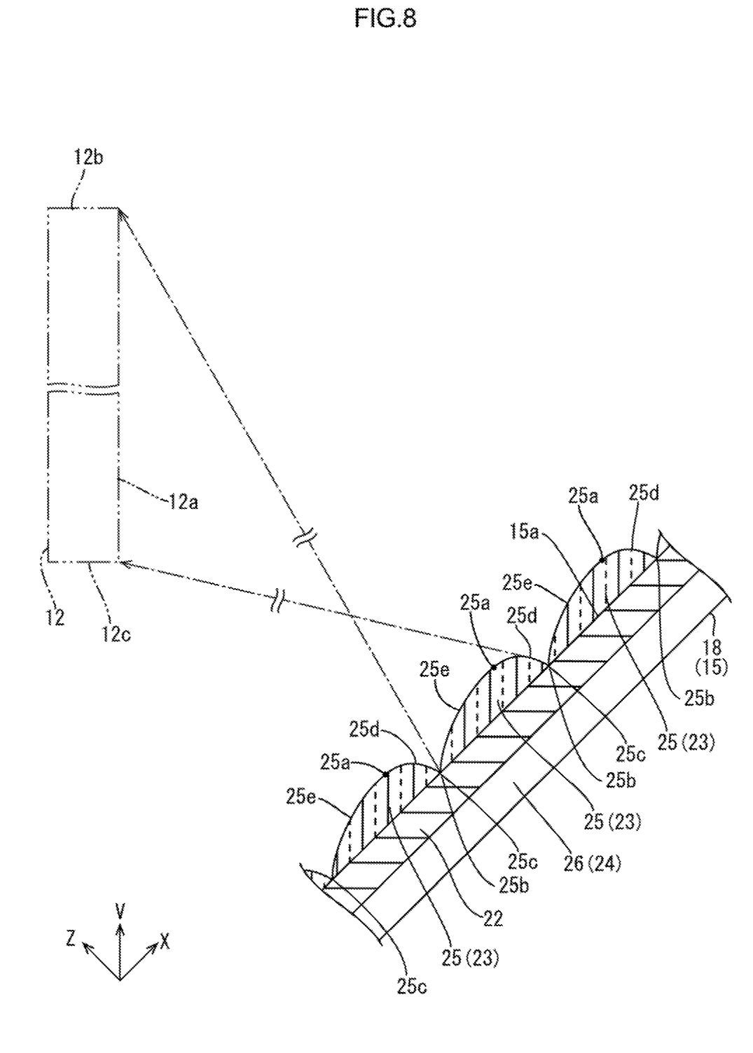

As illustrated in FIG. 4, the top-centered cylindrical lenses 26 included in the second lenticular lens portion 24 each have a substantially semispherical surface (lens surface) and have a top 26a at a substantially central position in the X-axis and the Y-axis direction. In other words, the top 26a of each top-centered cylindrical lens 26 is not displaced in the X-axis direction and the Y-axis direction. Contrary to this configuration, as illustrated in FIG. 8, the top-displaced cylindrical lenses 25, which are included in the first lenticular lens portion 23, each have a modified semispherical surface, i.e., aspherical surface (asymmetric surface), and have a top 25a displaced in the X-axis direction.

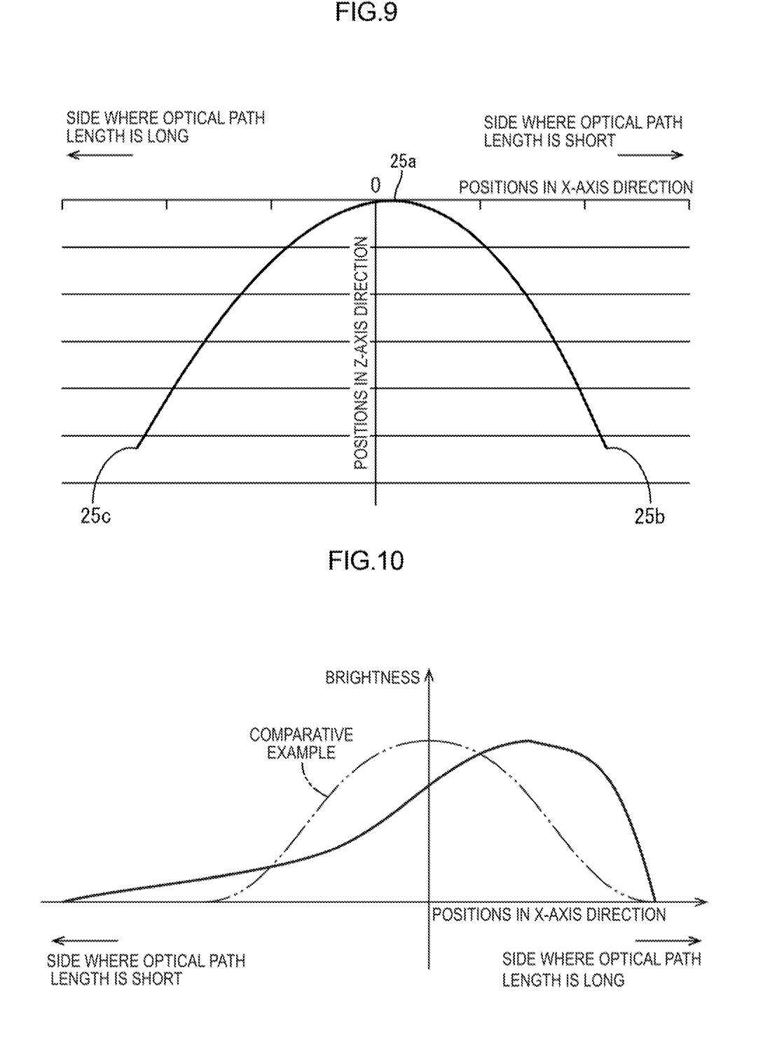

The configuration of the surface of the top-displaced cylindrical lens 25 is described in detail. As illustrated in FIG. 8, ends 25b and 25c of the top-displaced cylindrical lens 25 in the X-axis direction include a first end 25b at a side (right side in FIG. 8) where the optical path length of the projector light, which exits from the top-displaced cylindrical lens 25 to the projection surface 12a of the combiner 12, is short and a second send 25c at a side (left side in FIG. 8) where the optical path length of the projector light is long. As illustrated in FIG. 8 and FIG. 9, the top-displaced cylindrical lens 25 has the top 25a at the position displaced from the center in the X-axis direction to the first end 25b where the optical path length is short. Additionally, the top-displaced cylindrical lens 25 has different curvatures at a portion adjacent to the first end 25b and a portion adjacent to the second end 25c with the top 25a therebetween in the X-axis direction. A portion 25d extending from the top 25a to the first end 25b (side from which the projector light is projected toward the side where the optical path length is relatively short, in relation to the central position in the X-axis direction) has a relatively large curvature and the portion 25e extending from the top 25a to the second end 25c (side from which the projector light is projected toward the side where the optical path length is relatively long, in relation to the central position in the X-axis direction) has a relatively small curvature. Furthermore, in the top-displaced cylindrical lens 25, the portion 25d extending from the top 25a to the first end 25b has an aspherical shape (asymmetrical shape) in which the curvature thereof gradually increases with distance from the top 25a in the X-axis direction (toward the first end 25b). FIG. 9 is a graph indicating the configuration of the surface of the top-displaced cylindrical lens 25. The horizontal axis in FIG. 9 indicates positions in the X-axis direction and the vertical axis in FIG. 9 indicates positions in the Z-axis direction. The right end and the left end of the horizontal axis in the graph in FIG. 9 indicate the position of the first end 25b and the position of the second end 25c, respectively. In addition, the vertical axis in FIG. 9 takes the top 25a of the top-displaced cylindrical lens 25 as a reference point.

As described above, the top-displaced cylindrical lens 25 has the top 25a displaced toward the first end 25b, and thus the brightness peak of the exiting light (projector light) from the top-displaced cylindrical lens 25 is shifted, in relation to the central position in the X-axis direction, toward the first end 25b, i.e., toward the side where the optical path length of the projector light from the projector surface 15a to the projection surface 12a is relatively long. Specifically, in the top-displaced cylindrical lens 25, the light exiting from the portion 25d, which extends from the top 25a to the first end 25b, travels toward the side where the optical path length of the projector light is relatively short, in relation to the central position in the X-axis direction, and the light exiting from the portion 25e, which extends from the top 25a to the second end 25c, travels toward the side where the optical path length is relatively long, in relation to the central position in the X-axis direction, making the brightness distribution of the exiting light non-uniform as described above. FIG. 10 is a graph indicating the brightness distribution of the exiting light from the top-displaced cylindrical lens 25. The horizontal axis and the vertical axis in FIG. 10 indicate positions in the X-axis direction and the brightness of the exiting light, respectively. In FIG. 10, the right side of the horizontal axis is a side where the optical path length is long (side adjacent to the second end 25c) and the left side of the horizontal axis is a side where the optical path length is short (side adjacent to the first end 25b). In FIG. 10, a two-dot chain line indicates a brightness distribution of exiting light from a comparative example in which a cylindrical lens having a spherical surface and having a centered top is employed instead of the top-displaced cylindrical lens 25. In this comparative example, the brightness peak coincides with the central position in the X-axis direction.

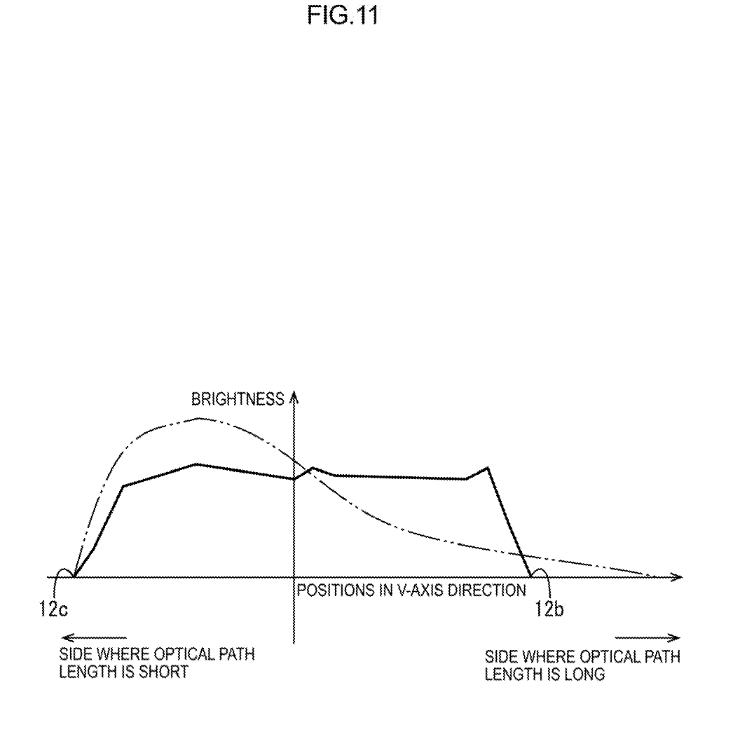

When the exiting light from the top-displaced cylindrical lens 25 with the above-described brightness distribution is projected onto the projection surface 12a of the combiner 12, the image projected onto the projection surface 12a has the following brightness distribution. Specifically, as illustrated in FIG. 11, the brightness distribution of the image projected onto the projection surface 12a is substantially flat over the entire area from the first end 12b to the second end 12c in the V-axis direction, which means that the brightness is sufficiently uniform. In addition, the brightness distribution of the image projected onto the projection surface 12a fits within the plane of the projection surface 12a in the V-axis direction and shows almost no spreading beyond the projection surface 12a. This means that the projector light projected toward the projection surface 12a is hardly projected outside the projection surface 12a and the projector light is efficiently used. Contrary to this, a two-dot chain line in FIG. 11 indicates a brightness distribution of an image that is obtained when the exiting light from the cylindrical lens according to the above-described comparative example is projected onto the projection surface 12a of the combiner 12. In the brightness distribution of the comparative example, the brightness peak is displaced toward the second end 12c in the V-axis direction, i.e., displaced toward the side where the optical path length is short, which means that the brightness is insufficiently made uniform and the brightness is non-uniform. In addition, the brightness distribution of the comparative example spreads beyond the plane of the projection surface 12a in the V-axis direction and a portion of the projector light travels beyond the first end 12b (side where the optical path length is long). This means that, in the comparative example, the projector light is insufficiently used and the light use efficiency is poor. FIG. 11 is a graph indicating the brightness distribution of the image projected onto the projection surface 12a of the combiner 12 in which the horizontal axis and the vertical axis indicate positions in the V-axis direction and the brightness of the image, respectively. In FIG. 11, the right side in the horizontal direction is the side where the optical path length is long (side adjacent to the first end 12b) and the left side in the horizontal axis is the side where the optical path length is short (side adjacent to the second end 12c).

The reason for the above-described result is explained. Specifically, the optical path length from the projector surface 15a of the screen 15 to the projection surface 12a of the combiner 12 changes depending on the position in the plane of the projector surface 15a in the X-axis direction and changes depending on the position in the plane of the projection surface 12a in the V-axis direction. Therefore, in the cylindrical lens according to the comparative example, which has the brightness peak of the exiting light coincidence with the central position in the X-axis direction (see the two-dot chain line in FIG. 10), when the exiting light as the projector light is projected onto the projection surface 12a of the combiner 12, the brightness in the brightness distribution in the projection surface 12a is relatively high at the side where the optical path length is short and is relatively low at the side where the optical path length is long, in relation to the central position in the V-axis direction. Furthermore, a portion of the projector light travels beyond the side where the optical path length is long and the portion is not used (see the two-dot chain line in FIG. 11). To overcome this problem, in the top-displaced cylindrical lens 25 according to the present embodiment, as illustrated in FIG. 10, the brightness peak of the exiting light is shifted, in relation to the central position in the X-axis direction, toward the side where the optical path length is long, and thus, when the exiting light as the projector light is projected onto the projection surface 12a of the combiner 12, as illustrated in FIG. 11, a large amount of the projector light is applied to the side of the projection surface 12a in the V-axis direction where the optical path length is long, which tends to have an insufficient amount of light, and a smaller amount of light is applied to the side in the V-axis direction where the optical path length is short, which tends to have too much light. In this configuration, the brightness a distribution in the projection surface 12a is flat without bias in the V-axis direction and the projector light does not travel beyond the side of the projection surface 12a where the optical path length is long in the V-axis direction. The above-described configuration makes the brightness on the projection surface 12a of the combiner 12 uniform and improves the light use efficiency, thereby reliably reducing a deterioration in the display quality, which may be caused by the positional relationship between the combiner 12 and the screen 15.

Furthermore, since the portion 25e of the top-displaced cylindrical lens 25, which extends from the top 25a to the second end 25c, has the relatively small curvature, the amount of the light projected onto the projection surface 12a of the combiner 12 from the portion 25e is made large and the projection area of the projection surface 12a is made small, and since the portion 25d extending from the top 25a to the first end 25b has the relatively large curvature, the amount of light projected onto the projection surface 12a of the combiner 12 from the portion 25d is made small and the projection area of the projection surface 12a is made large. This makes the brightness distribution in the projection surface 12a more uniform. In addition, since the portion 25d of the top-displaced cylindrical lens 25, which extends from the top 25a to the first end 25b, has the curvature gradually increasing with distance from the top 25a in the X-axis direction, the portion 25d is aspherical, and thus the brightness in the plane of the projection surface 12a of the combiner 12, which may be too high on the side where the optical path length from the top-displaced cylindrical lens 25 is short, is more reliably reduced, and thus the brightness distribution is more reliably made uniform.

The surface shape of the top-displaced cylindrical lens 25 illustrated in FIG. 9, which is aspherical, is obtained by using the following formula (1). The letters “z”, “r”, “c”, and “k” in the formula (1) respectively refer to “an amount of sagging (position in the Z-axis direction)”, “a distance from the optical axis (position in the X-axis direction”), “a curvature (reciprocal of radius of curvature)”, and the conic constant (conic constant). In particular, in the top-displaced cylindrical lens 25, the portion 25e extending from the top 25a to the second end 25c has the surface shape in which the conic constant is negative, i.e., the portion 25e has an aspherical surface.

$$\begin{matrix}[ formula 1 ] & \\ z = \frac{{cr}^{2}}{1 + \sqrt{1 - ( 1 + k ) {c}^{2} {r}^{2}}} + {\sum }_{n = 2}^{10} {c}_{2 n} {r}^{2 n} & ( 1 )\end{matrix}$$

As explained above, the head-up display (projection type display apparatus) 10 according to the present embodiment includes the projector 11 configured to project an image and having the projector surface 15a, the combiner (projection member) 12 having the projection surface 12a onto which the image projected by the projector 11 is projected to allow an observer to see a virtual image, and the lenticular lens sheet (lens member) 18 included in the projector 11. The projection surface 12a is tilted relative to the projector surface 15a of the projector 11. The lenticular lens sheet 18 includes a plurality of top-displaced cylindrical lenses 25 arranged in the tilting direction tilted relative to the projection surface 12a. The top-displaced cylindrical lenses (top-displaced lenses) 25 each include the top 25a displaced such that the brightness peak of projector light is shifted, in relation to the central position in the tilting direction, toward the side where the optical path length of the projector light from the projector surface 15a to the projection surface 12a is relatively long.

With this configuration, the light from the projector 11, which is configured to project an image, is projected by the combiner 12 so that an observer sees the light as a virtual image. Since the combiner 12 is arranged such that the projection surface 12a is tilted relative to the projector surface 15a of the projector 11, the brightness distribution in the plane of the projection surface 12a may be non-uniform or a portion of light is unlikely to be projected onto the projection surface 12a. To solve the problem, the lenticular lens sheet 18 included in the projector 11 includes the top-displaced cylindrical lenses 25 arranged in the tilting direction. The top-displaced cylindrical lenses 25 each have the top 25a displaced such that the brightness peak of the projector light is shifted, in relations to the central position in the tilting direction, toward the side where the optical path length of the projector light from the projector surface 15a to the projection surface 12a is relatively long. This compensates for the lack of brightness at the side where the optical path length from the top-dig laced cylindrical lens 25 is long and reduces the brightness, which may be too high at the side where the optical path length is short, making the brightness distribution in the plane of the projection surface 12a of the combiner 12 uniform. Furthermore, this configuration reduces the amount of light not projected onto the projection surface 12a of the combiner 12, improving the light use efficiency and thus improving the brightness of the projection surface 12a.

Furthermore, in the lenticular lens sheet 18, the top-displaced cylindrical lenses 25 each have different curvatures at the portions on opposite sides of the top 25a. The portion 25e from which the projector light is projected toward the side where the optical path length is relatively long, in relation to the central position in the tilting direction, has a relatively small curvature, and the portion 25d from which the projector light is projected toward the side where the optical path length is relatively short, in relation to the central position in the tilting direction, has a relatively large curvature. In the top-displaced cylindrical lens 25, the amount of light to be projected onto the projection surface 12a of the combiner 12 tends to increase and the projection area of the projection surface 12a tends to decrease as the curvature decreases, and the amount of light to be projected onto the projection surface 12a of the combiner 12 tends to decrease and the projection area of the projection surface 12a tends to increase as the curvature increases. Thus, the brightness distribution in the projection surface 12a of the combiner 12 is made more uniform and the amount of light not projected onto the projection surface 12a is reduced by the top-displaced cylindrical lens 25 having the different curvatures at portions on opposite sides of the top 25a in which the portion 25e from which the projector light is projected toward the side where the optical path length is relatively long, in relation to the central position in the tilting direction, has a relatively small curvature and the portion 25d from which the projector light is projected toward the side where the optical path length is relatively short, in relation to the central position in the tilting direction, has a relatively large curvature.

Furthermore, in the lenticular lens sheet 18, the portion 25d of the top-displaced cylindrical lens 25, from which the projector light is projected toward the side where the optical path length is relatively short, in relation to the central position in the tilting direction, has the curvature gradually increasing with distance from the top 25a in the titling direction. In this configuration, the portion 25d of the top-displaced cylindrical lens 25 at the side from which the projector light is projected toward the side where the optical path length is relatively short, in relation to the central position in the tilting direction, has the aspherical shape, since the curvature thereof gradually increases with distance from the top 25a in the tilting direction. This more reliably reduces the brightness in the plane of the projection surface 12a of the combiner 12, which may be too high at the side where the optical path length from the top-displaced cylindrical lens 25 is short, and thus more reliably making the brightness distribution more uniform.

Furthermore, in the lenticular lens sheet 18, the top-displaced cylindrical lenses 25 each have a convex shape, and the top 25a is displaced toward the first end 25b (end) at the side where the optical path length is relatively short, which is one of the ends 25b, 25c in the tilting direction. In this configuration, the brightness peak of the projector light from the top-displaced cylindrical lens 25 having the convex shape is shifted, in relation to the central position in the tilting direction, toward the side where the optical path length of the projector light from the projector surface 15a to the projection surface 12a is relatively long. This compensates for the lack of brightness at the side where the optical path length from the top-displaced cylindrical lens 25 having the convex shape is long and reduces the brightness, which may be too high at the side where the optical path length is short, making the brightness distribution in the plane of the projection surface 12a of the combiner 12 uniform. In addition, this configuration reduces the amount of light not projected onto the projection surface 12a of the combiner 12, improving the light use efficiency and thus improving the brightness of the projection surface 12a.

Furthermore, the lenticular lens sheet 18 at least includes the first lenticular lens portion 23 including the plurality of top-displaced cylindrical lenses 25, as the plurality of top-displaced lenses, extending along the projector surface 15a in a direction intersecting the tilting direction and the second lenticular lens portion 24 including the plurality of top-centered cylindrical lenses 26 extending in the tilting direction and arranged along the projector surface 15a in a direction perpendicular to the tilting direction. The top-centered cylindrical lenses 26 each have the top 25a at the central position in the tilting direction. In this configuration, since the plurality of top-displaced cylindrical lenses 25 included in the first lenticular lens portion 23 and the plurality of top-centered cylindrical lenses 26 included in the second lenticular lens portion 24 intersect each other, the application area of the projector light projected onto the combiner 12 has a rectangular shape. This also allows the application area of the projection light projected by the combiner 12 to have a rectangular shape, enabling the light to be efficiently collected within the visible range (eye box) of the observer, and thus providing high light use efficiency, for example.

Furthermore, in the lenticular lens sheet 18, the extending direction of the plurality of top-displaced cylindrical lens 25 and the extending direction of the plurality of top-centered cylindrical lens 26 are perpendicular to each other. In this configuration, the application area of the projector light projected from the lenticular lens sheet 18 onto the combiner 12 and the application area of the projection light from the combiner 12 have a more preferable rectangular shape, allowing the light to be more efficiently collected within the visible range (eye box) of the observer. This provides high light use efficiency, for example.

Furthermore, the lenticular lens sheet 18 includes the sheet base (base) 22 having the first planar surface on which the first lenticular lens portion 23 is disposed and the second planar surface on which the second lenticular lens portion 24 is disposed. In this configuration, in contrast to the case where the both lenticular lens portions are disposed on one of the planar surfaces of the sheet base 22, the entire area of each planar surface of the sheet base 22 is used as the formation area of the corresponding lenticular lens portion 23, 24.

Furthermore, the projector 11 at least includes the lenticular lens sheet 18, the MEMS mirror device 14 at least including a mirror configured to reflect light and a driver (mirror driver) configured to drive the mirror such that the lenticular lens sheet 18 is scanned by the light reflected by mirror, and the laser diode (light source) 13 configured to provide light to the MEMS mirror device 14. In this configuration, the light from the laser diode 13 is reflected by the mirror included in the MEMS mirror device 14. Since the mirror is driven by the driver, the light reflected by the driven mirror scans the lenticular lens sheet 18. In addition, since the lenticular lens sheet 18 includes the top-displaced cylindrical lenses 25, the brightness distribution in the plane of the projection surface 12a of the combiner 12 onto which the light from the lenticular lens sheet 18 is projected is reliably made uniform and the light use efficiency is improved.

Furthermore, the projector 11 includes the isotropic microlens array 20 from which isotropic exiting light exits. The isotropic microlens array 20 is located farther than the lenticular lens sheet 18 from the combiner 12 and includes the top-centered microlenses 21 arranged in the tilting direction and in the direction intersecting the tilting direction in the plane of the projector surface 15a. The top-centered microlenses 21 each have a polygonal planar shape with five or more sides or a circular planar shape and has the top 21a at the central position in the tilting direction. In this configuration, the isotropic exiting light from the isotropic microlens array 20 including the top-centered microlenses 21 is projected onto the combiner 12 through the lenticular lens sheet 18. The isotropic microlens array 20 having such a configuration reliably reduces speckle.

Furthermore, the projector 11 includes the field lens 16 located closer than the lenticular lens sheet 18 to the combiner 12. In this configuration, the light from the lenticular lens sheet 18 is projected onto the combiner 12 through the field lens 16. The traveling direction of the light is regulated by the field lens 16, reducing the amount of light not projected onto the projection surface 12a of the combiner and thus improving the light use efficiency.

### Second Embodiment

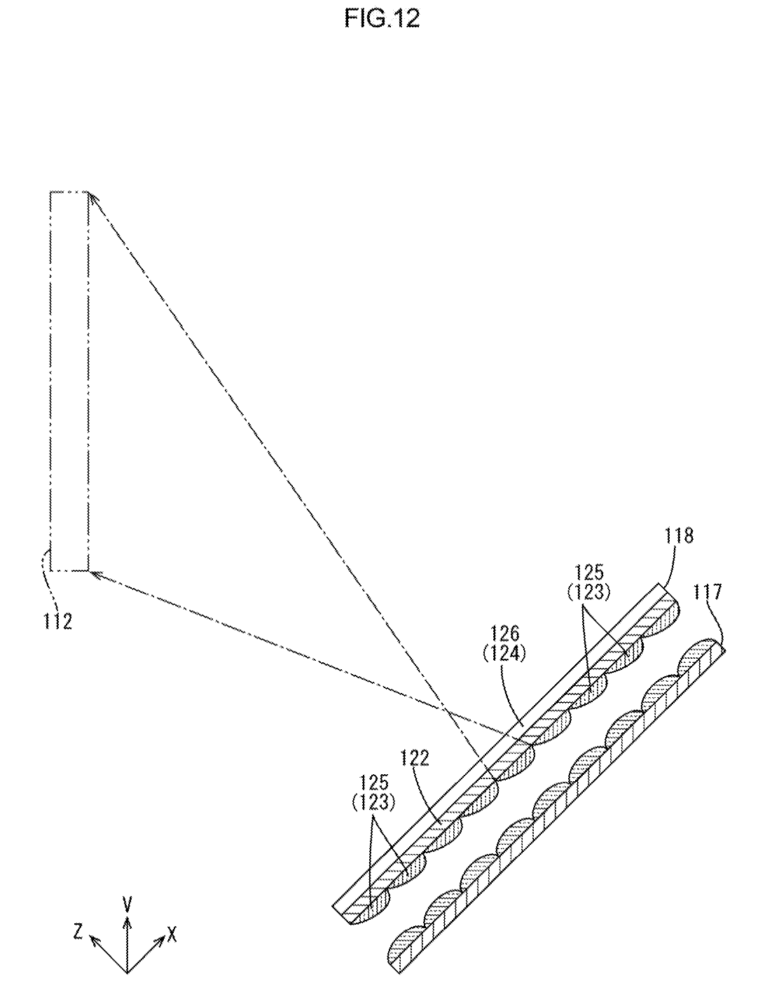

A second embodiment of the present invention is described with reference to FIG. 12. In the second embodiment, a first lenticular lens portion 123 and a second lenticular lens portion 124 included in a lenticular lens sheet 118 are located in inverted positions. The configuration, operation, and effect similar to those in the above-described first embodiment are not described.

As illustrated in FIG. 12, in the lenticular lens sheet 118 according to this embodiment, the second lenticular lens portion 124 (top-centered cylindrical lens 126) is disposed on a first planar surface of a sheet base 122, i.e., the planar surface adjacent to a combiner 112, and the first lenticular lens portion 123 (top-displaced cylindrical lens 125) is disposed on a second planar surface of the sheet base 122 i.e., the planar surface adjacent to an isotropic microlens sheet 117 (side opposite the combiner 112). This configuration also provides the operation and effect similar to those in the above-described first embodiment.

### Third Embodiment

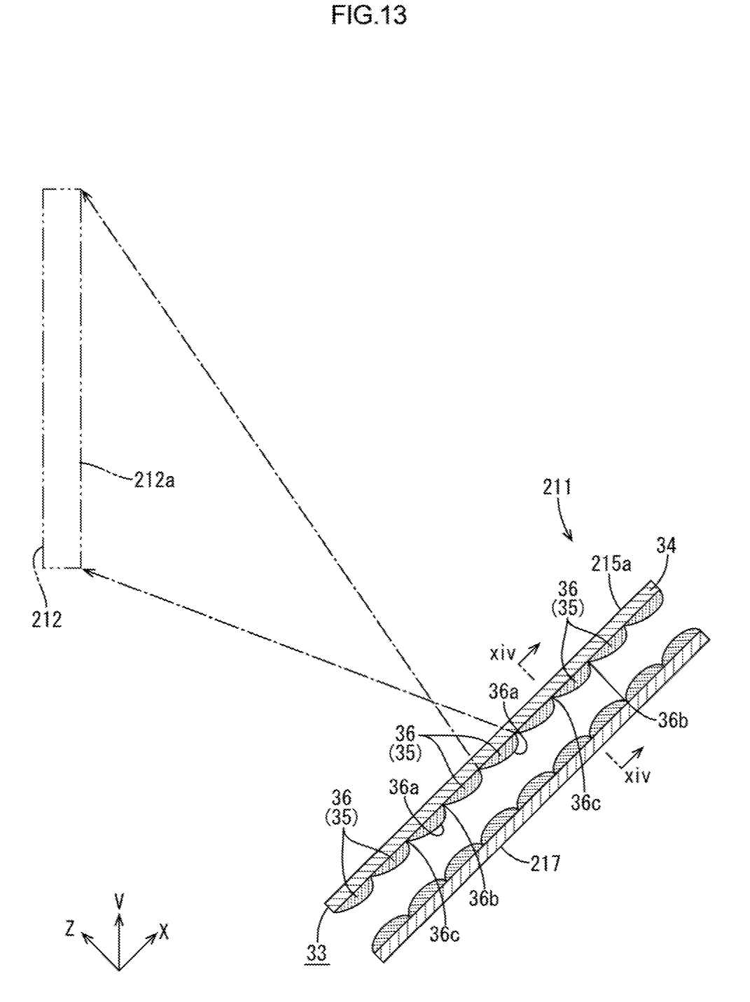

A third embodiment of the present invention is described with reference to FIG. 13 to FIG. 15. The third embodiment is different from the above-described first embodiment in that a projector 211 includes an isotropic microlens sheet 33 as the lens member. The configuration, operation, and effect similar to those in the above-described first embodiment are not described.

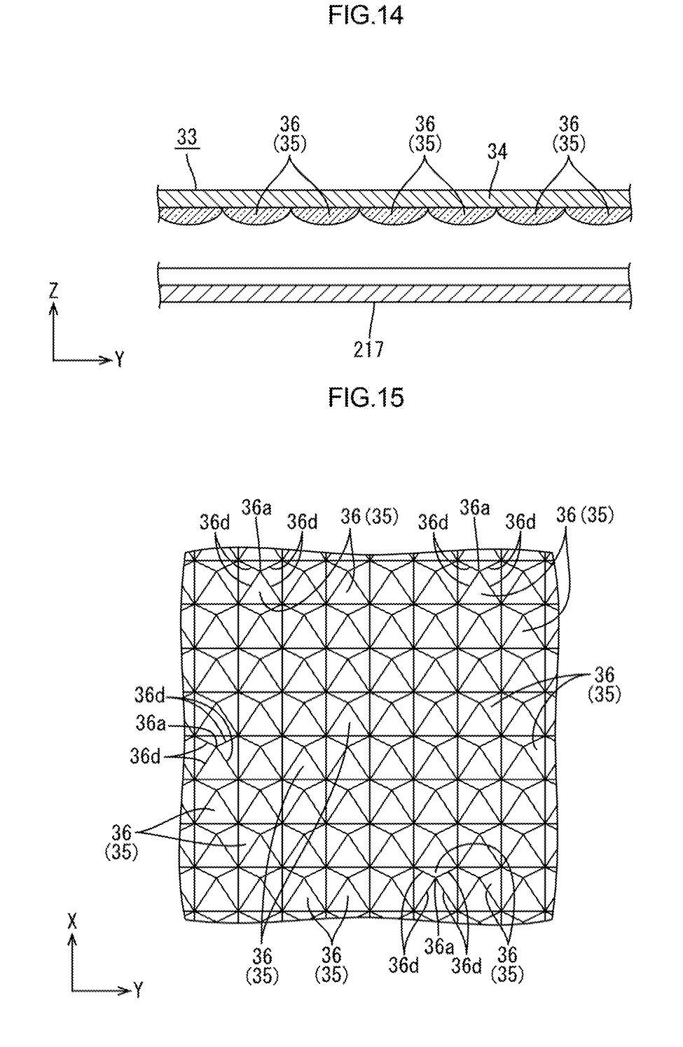

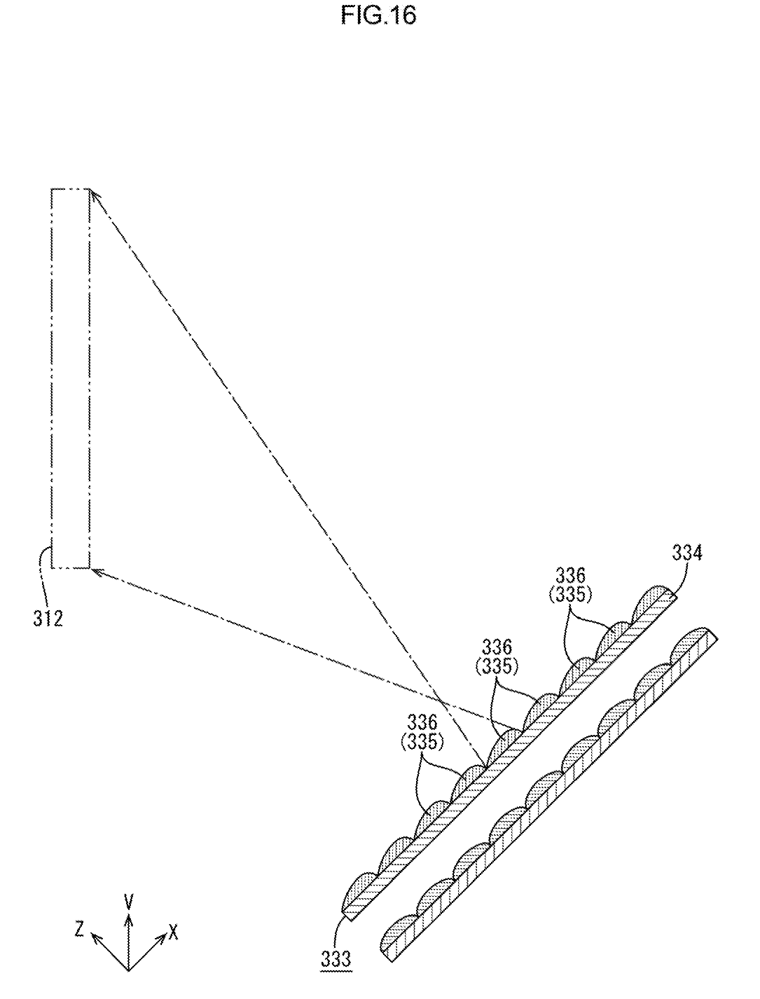

As illustrated in FIG. 13 and FIG. 14, the projector 211 according to this embodiment includes the anisotropic microlens sheet 33, instead of the lenticular lens sheet 18 described in the above-described first embodiment, located closer than an isotropic microlens sheet 217 to a combiner 212. The anisotropic microlens sheet 33 includes a sheet base 34 and an anisotropic microlens array 35 disposed on a second planar surface of the sheet base 34, i.e., the planar surface remote from the combiner 212. The anisotropic microlens array 35 includes a plurality of top-displaced microlenses 36 arranged in the X-axis direction and the Y-axis direction on the planar surface of the sheet base 34. As illustrated in FIG. 13, the cross-sectional shape of the top-displaced microlens 36 taken in the X-axis direction is aspherical, and a top 36a thereof is displaced toward a first end 36b in the X-axis direction (side opposite a second end 36c), i.e., side where the optical path length of the projector light is short. As illustrated in FIG. 14, the cross-sectional shape of the top-displaced microlens 36 taken in the Y-axis direction is a substantially semispherical shape (see FIG. 15).

As illustrated in FIG. 15, the top-displaced microlenses 36 each have a quadrilateral planar shape (rectangular planar shape) and fill the planar surface of the sheet base 34 with almost no space therebetween. The top-displaced microlens 36 has an outline shaped like a combination of the top-displaced cylindrical lens 25 and the top-centered cylindrical lens 26, which are described in the above-described first embodiment (see FIG. 3 and FIG. 4) and has the curvature discontinuously changing with ridges 36d connecting the top 36a with four corners therebetween. Two of the four ridges 36d that extend from the top 36a to the second end 36c in the X-axis direction are longer than two of the ridges 36d that extend to the first end 36b. As described above, the top-displaced microlenses 36 included in the anisotropic microlens array 35 each have a quadrilateral planar shape, and thus the exiting light from the top-displaced microlens 36 is anisotropic. Specifically, since the sides shaping the outline of the top-displaced microlens 36 extend in the X-axis direction and the Y-axis direction, the application area of the projector light has a substantially rectangular shape when the exiting light from the top-displaced microlens 36 is projected onto a projection surface 212a of the combiner 212. The application area of the projector light projected onto the projection surface 212a of the combiner 212 is controlled by proper adjustment of the ratio of lengths of the sides of the top-displaced microlens 36 or the lens pitch, enabling the application area of the projector light to have a horizontally elongated rectangular shape corresponding to the visible range (eye box) of the observer. This enables the light to be efficiently collected within the visible range of the observer, providing high light use efficiency. Furthermore, since the top-displaced microlens 36 has the outline shaped like a combination of the top-displaced cylindrical lens 25 and the top-centered cylindrical lens 26 (see FIG. 3 and FIG. 4), which are described in the first embodiment, and the curvature thereof changes with the four ridges 36d connecting the top 36a with the four corners therebetween, the brightness difference (non-uniformity in brightness and darkness) in the projection surface 212a is less likely to be recognized when the exiting light is projected onto the projection surface 212a of the combiner 212, providing a high display quality.

As described above, in this embodiment, the anisotropic microlens sheet (lens member) 33 at least includes the anisotropic microlens array 35 from which the anisotropic exiting light exits. The anisotropic microlens array 35 includes a plurality of anisotropic microlenses 36, as the plurality of top-displaced lenses, arranged in the tilting direction and in the direction intersecting the tilting direction in the plane of the projector surface 215a. The anisotropic microlenses 36 each have a quadrilateral planar shape. In this configuration, since the top-displaced microlens 36 included in the anisotropic microlens array 35 has a quadrilateral planar shape, the light exiting from the top-displaced microlens 36 is anisotropic. This allows the application area of the projector light projected onto the combiner 212 to have a rectangular shape. This also allows the application area of the projection light projected by the combiner 212 to have a rectangular shape, enabling the light to be efficiently collected within the visible range (eye box) of the observer and thus providing high light use efficiency, for example.

### Fourth Embodiment

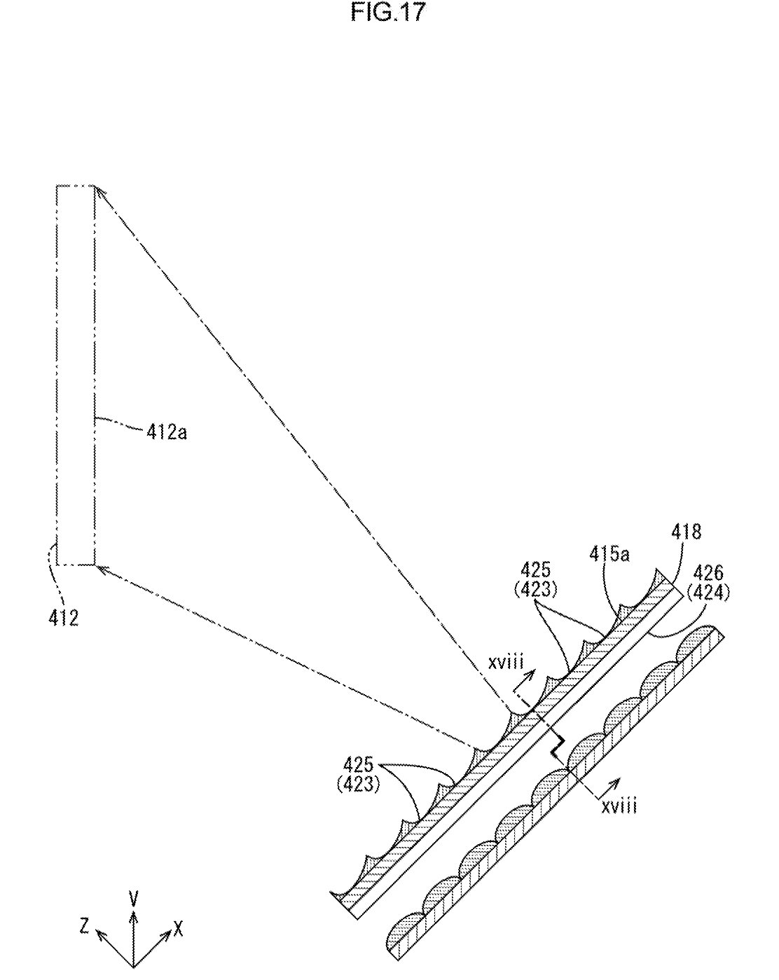

A fourth embodiment of the present invention is described with reference to FIG. 16. The fifth embodiment is different from the above-described third embodiment in that an anisotropic microlens sheet 333 is inverted upside down. The configuration, operation, and effect similar to those in the third embodiment are not described.

As illustrated in FIG. 16 the anisotropic microlens sheet 333 according to this embodiment includes an anisotropic microlens array 335 including top-displaced microlenses 336 on a first planar surface of a sheet base 334, i.e., a planer surface adjacent to a combiner 312. This configuration also provides the operation and effect similar to those in the third embodiment.

### Fifth Embodiment

A fifth embodiment of the present invention is described with reference to FIG. 17 to FIG. 19. The sixth embodiment is different from the above-described first embodiment in that each of cylindrical lenses 425 and 426 included in a lenticular lens sheet 418 has a concave shape. The configuration, operation, and effect similar to those in the above-described first embodiment are not described.

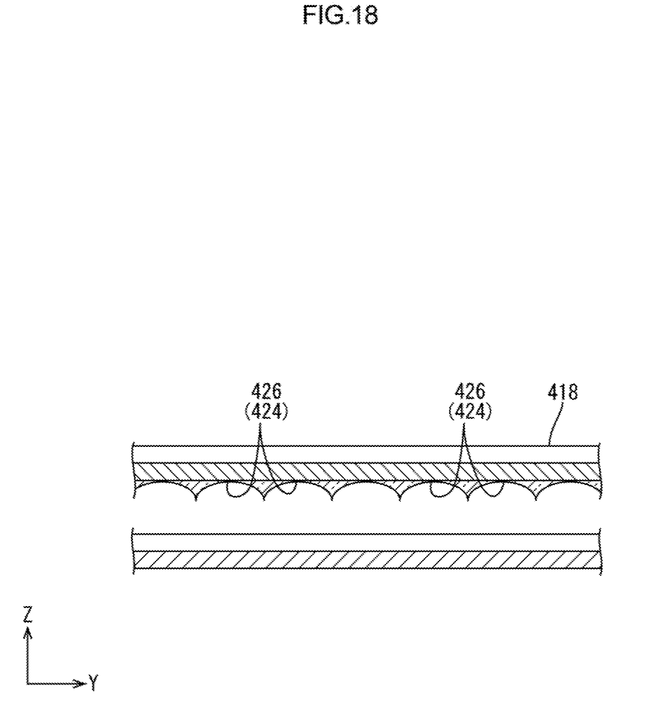

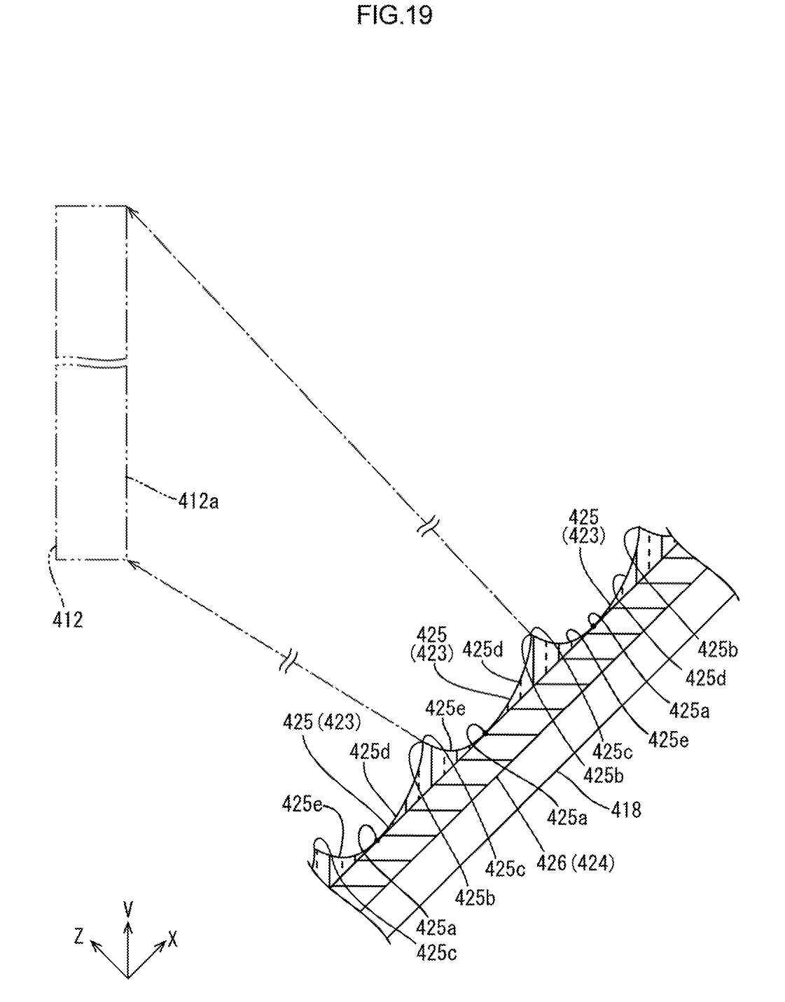

As illustrated in FIG. 17 and FIG. 18, the lenticular lens sheet 418 according to this embodiment includes a first lenticular lens portion 423 including the top-displaced cylindrical lenses 425 each having a concave shape and a second lenticular lens portion 424 including the top-centered cylindrical lenses 426 each having a concave shape. As illustrated in FIG. 18, the top-centered cylindrical lens 426 has a surface (lens surface) having a substantially semispherical shape, and a top 426a is located at the substantially central position in the X-axis direction and the Y-axis direction and not displaced. As illustrated in FIG. 19, the top-displaced cylindrical lens 425 has a surface having a modified semispherical shape, i.e., aspherical surface, and a top 425a is displaced from the central position in the X-axis direction toward a second end 425c where the optical path length is short. Specifically, the top 425a of the top-displaced cylindrical lens 425 is displaced in the X-axis direction toward the side opposite the side toward which the top-displaced cylindrical lens 25 in the above-described first embodiment is displaced. In addition, the top-displaced cylindrical lens 425 has different curvatures at a portion adjacent to a first end 425b and at a portion adjacent to the second end 425c with the top 425a therebetween. A portion 425d extending from the top 425a to the first end 425b (side from which the projector light is projected to the side where the optical path length is relatively long, in relation to the central position in the X-axis direction) has a relatively small curvature and a portion 425e extending front the top 425a to the second end 425c (side from which the projector light is projected to the side where the optical path length is relatively short, in relation to the central position in the X-axis direction) has a relatively large curvature. In addition, in the top-displaced cylindrical lens 425, the portion 425e extending from the top 425a to the second end 425c has as aspherical shape in which the curvature gradually increases with distance from the top 425a in the X-axis direction (toward the second end 425c).

As described above, in the top-displaced cylindrical lens 425, since the top 425a is displaced toward the second end 425c, the brightness peak of the exiting light (projector light) is shifted, in relation to the central position in the X-axis direction, toward the first end 425b, i.e., toward the side where the optical path length of the projector light from the projector surface 415a to the projection surface 412a is relatively long (see FIG. 10). More specifically described, in the top-displaced cylindrical lens 425, the light exiting from the portion 425d extending from the top 425a to the first end 425b travels toward the side where the optical path length of the projector light is relatively long, in relation to the central position in the X-axis direction, and the light exiting from the portion 425e extending from the top 425a to the second end 425c travels toward the side where the optical path length of the projector light is relatively short, in relation to the central position in the X-axis direction, and thus the brightness distribution of the exiting light is non-uniform as described above. The exiting light in such a brightness distribution is projected onto the projection surface 412a of the combiner 412, allowing the image projected onto the projection surface 412a to have a uniform brightness (see FIG. 11).

As described above, in this embodiment, the lenticular lens sheet 418 includes the top-displaced cylindrical lens 425 having the concave shape, and the top 425a is displaced toward the second end (end) 425c at the side where the optical path length is relatively short, which is one of the ends 425b and 425c in the tilting direction. In this configuration, the brightness peak of the projector light from the top-displaced cylindrical lens 425 having the concave shape is shifted, in relation to the central position in the tilting direction, toward the side where the optical path length of the projector light from the projector surface 415a to the projection surface 412a is relatively long. This compensates for lack of brightness at the side where the optical path length from the top-displaced cylindrical lens 425 having the concave shape is long and reduces the brightness, which may be too high at the side where the optical path length is short, making the brightness distribution in the plane of the projection surface 412a of the combiner 412 uniform. In addition, the amount of light not projected onto the projection surface 412a of the combiner 412 is reduced, improving the light use efficiency and thus improving the brightness of the projection surface 412a.

### Sixth Embodiment

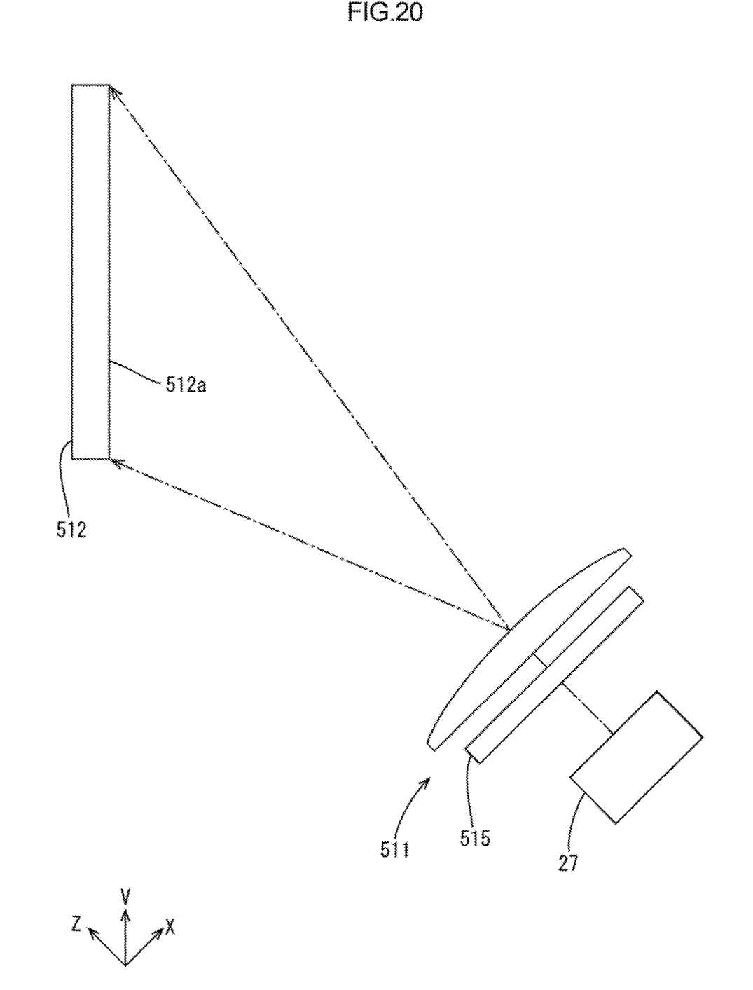

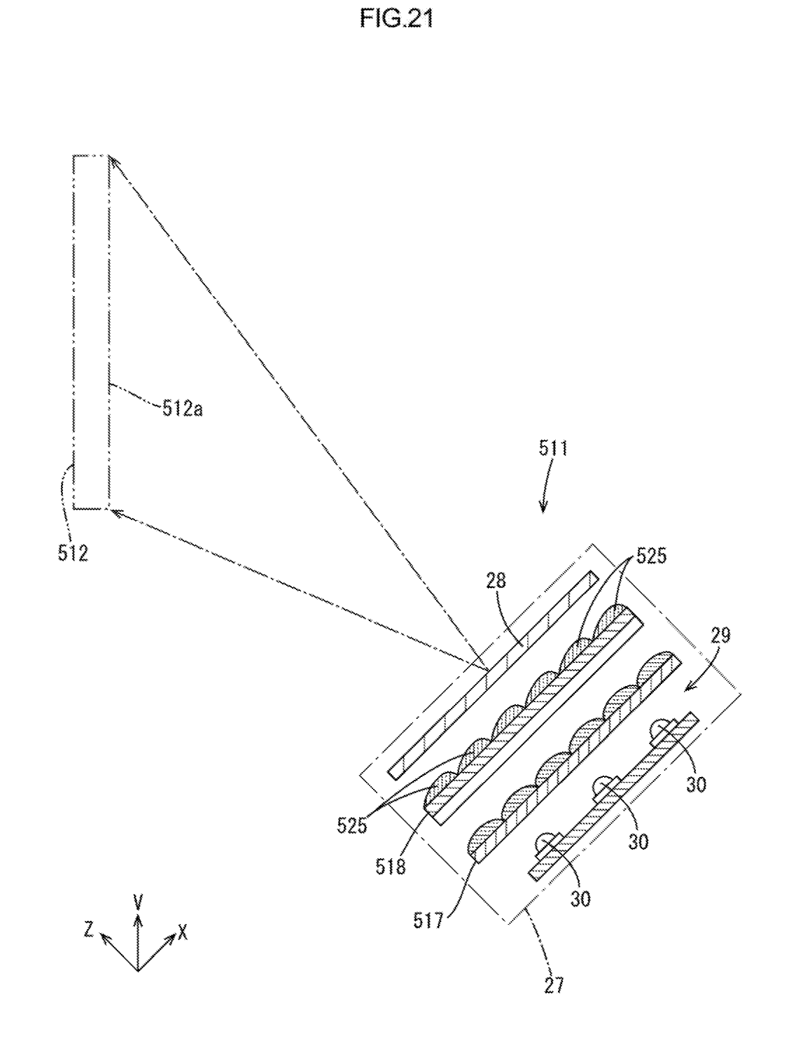

A sixth embodiment of the present invention is described with reference to FIG. 20 or FIG. 21. The seventh embodiment is different from the first embodiment in that a liquid crystal display unit 27 is used as the light source and the display device of a projector 511. The configuration, operation, and effect similar to those in the first embodiment are not described.

As illustrated in FIG. 20, the projector 511 according to this embodiment includes the liquid crystal display unit 27 as the light source and the display device. As illustrated in FIG. 21, the liquid crystal display unit 27 includes a liquid crystal panel 28 configured to display an image and a backlight unit (lighting unit) 29 configured to provide light to the liquid crystal panel 28 for display. The backlight unit 29 includes laser diodes 30, which are light sources, an isotropic microlens sheet 517, which is located closer than the laser diodes 30 to the liquid crystal panel 28, and a lenticular lens sheet 518, which is located closer than the isotropic microlens sheet 517 to the liquid crystal panel 28. The configurations of the isotropic microlens sheet 517 and the lenticular lens sheet 518 are the same as those of the isotropic microlens sheet 17 and the lenticular lens sheet 18 included in the screen 15 in the above-described first embodiment. Thus, the light from the laser diodes 30 is applied to the liquid crystal panel 28 after the optical effect is applied to the light by the isotropic microlens sheet 517 and the lenticular lens sheet 518. The light from the liquid crystal panel 28 is applied to a combiner 512 and is projected by the combiner 512, so that an observer sees the light as a virtual image. Since the backlight unit 29 configured to apply light to the liquid crystal panel 28 includes the lenticular lens sheet 518 including top-displaced cylindrical lenses 525, the brightness distribution in a plane of a projection surface 512a of the combiner 512, onto which the light from the liquid crystal panel 28 is projected, is reliably made uniform and the light use efficiency is improved.

The exiting light from the liquid crystal panel 28 is linearly polarized light, and thus, a polarization conveyor (not illustrated), which is configured to convert the linearly polarized light into circularly polarized light, is disposed between the liquid crystal display unit 27 and a screen 515 illustrated in FIG. 20. The polarization convertor includes a retardation plate (quarter-wave plate) configured to cause a phase difference of a quarter λ, for example, and is configured to convert the linearly polarized light from the liquid crystal display unit 27 into left or right circularly polarized light. The screen 515 may have the same configuration as that in the above-described first embodiment or may have another configuration.

As described above, in this embodiment, the projector 511 at least includes the liquid crystal panel (display panel) 28 and the backlight unit (lighting unit) 29 configured to apply light to the liquid crystal panel 28. The backlight unit 29 at least includes the lenticular lens sheet 518 and the laser diode (light source) 30 configured to apply light to the lenticular lens sheet 518. In this configuration, the light from the laser diode 30 is applied to the liquid crystal panel 28 after the optical effect is applied to the light by the lenticular lens sheet 518. The light from the liquid crystal panel 28 is projected onto the combiner 512 and projected by the combiner 512, enabling the observer to see the light as a virtual image. Since the backlight unit 29 configured to apply light to the liquid crystal panel 28 includes the lenticular lens sheet 518 including the top-displaced cylindrical lenses 525, the brightness distribution in the plane of the projection surface 512a of the combiner 512, onto which the light from the display panel is projected, is reliably made uniform and the light use efficiency is improved.

### Seventh Embodiment

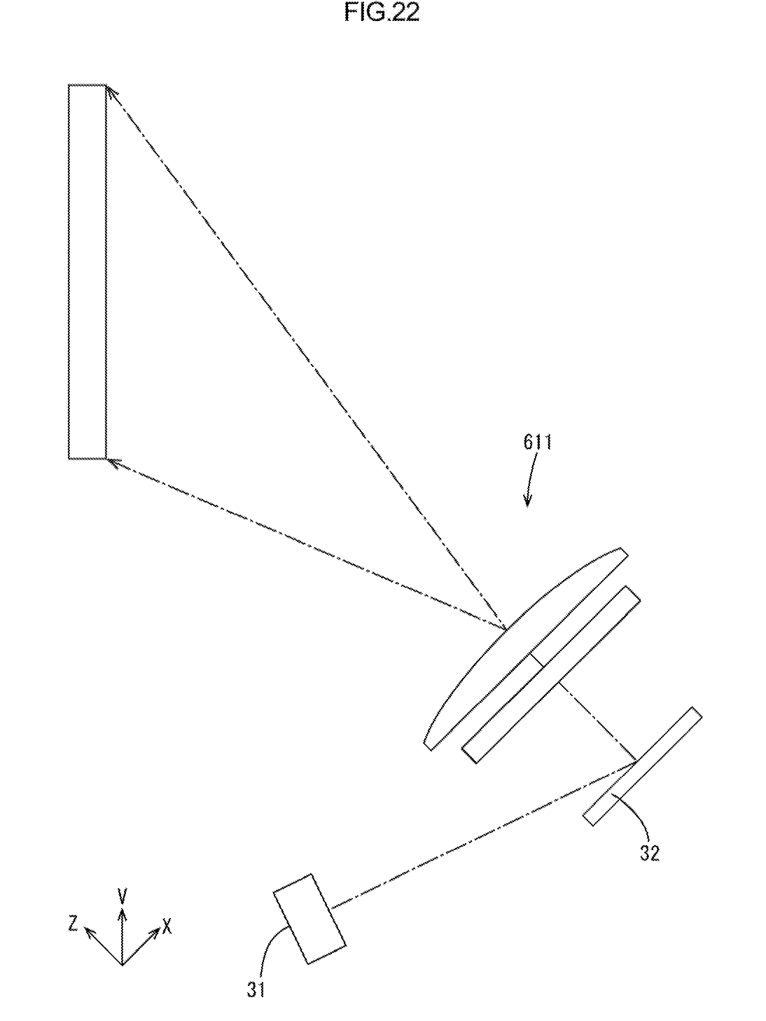

A seventh embodiment of the present invention is described with reference to FIG. 22. The eighth embodiment is different from the above-described first embodiment in that a projector 611 includes LED 31 as the light source and a DMD display device 32 as the display device. The configuration, operation, and effect similar to those in the above-described first embodiment are not described.

As illustrated in FIG. 22, the projector 611 according to this embodiment includes the LED 31 as the light source, instead of the laser diode 13, in the above-described first embodiment. The LED 31 includes a red LED element configured to emit red light having a wavelength within a wavelength range of red, a green LED element configured to emit green light having a wavelength within a wavelength range of green, and a blue LED element configured to emit blue light having a wavelength within a wavelength range of blue. The LED elements of the above-described colors included in the LED 31 emit non-polarized light. The LED elements of the above-described colors as the light source are not illustrated. The LED 31 emits red, green, and blue light at a predetermined order and timing.

Other components of the projector 611 according to this embodiment than the light source are also changed to different components. Instead of the MEMS mirror device 14 (see FIG. 2) in the above-described first embodiment, the projector 611 includes the DMD (Digital Micromirror Device) display device 32. The DMD display device 32 includes a plurality of minute micromirrors, which make up display pixels, arranged in a plane in a matrix and a semiconductor device such as a TFT (the micromirror and the TFT are not illustrated) configured to control the operation of each micromirror. In the DMD display device 32, the operation of the micromirror is controlled in synchronization with timing of light emission of red light, green light, and blue light from the LEDs 31, enabling the amount of light of each color reflected by the DMD display device 32 to be controlled by each micromirror (each display pixel). This allows a color image to be displayed. This configuration also provides the operation and effect similar to those in the above-described first embodiment.

A first polarization convertor (not illustrated) configured to convert non-polarized light from the LED 31 into linearly polarized light and a second polarization convertor (not illustrated) configured to selectively convert the linearly polarized light converted by the first polarization convertor into a left circularly polarized light or right circularly polarized light are disposed between the LED 31 and the DMD display device 32. The first polarization convertor includes one of a PS convertor, a polarizing plate, and a reflective polarizing plate, for example, and converts the non-polarized light from the LED 31 into linearly polarized light. The second polarization convertor includes a retardation plate (quarter-wave plate) configured to cause a phase difference of a quarter λ, for example, and is configured to convert the linearly polarized light from the first polarization convertor into left or right circularly polarize light.

### Eighth Embodiment

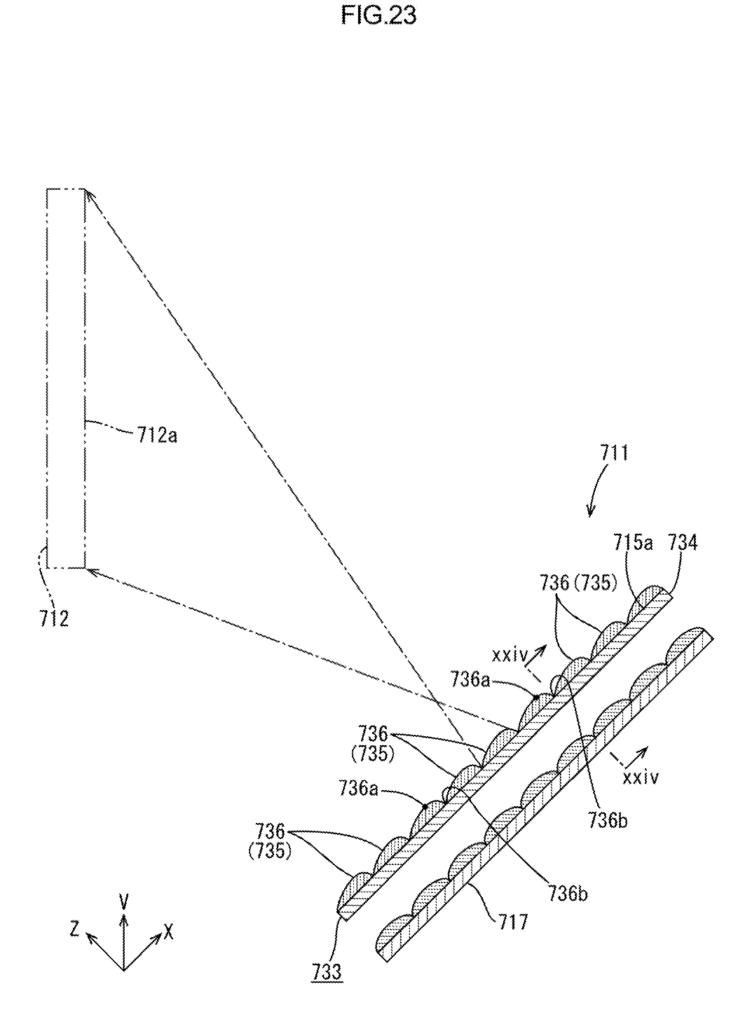

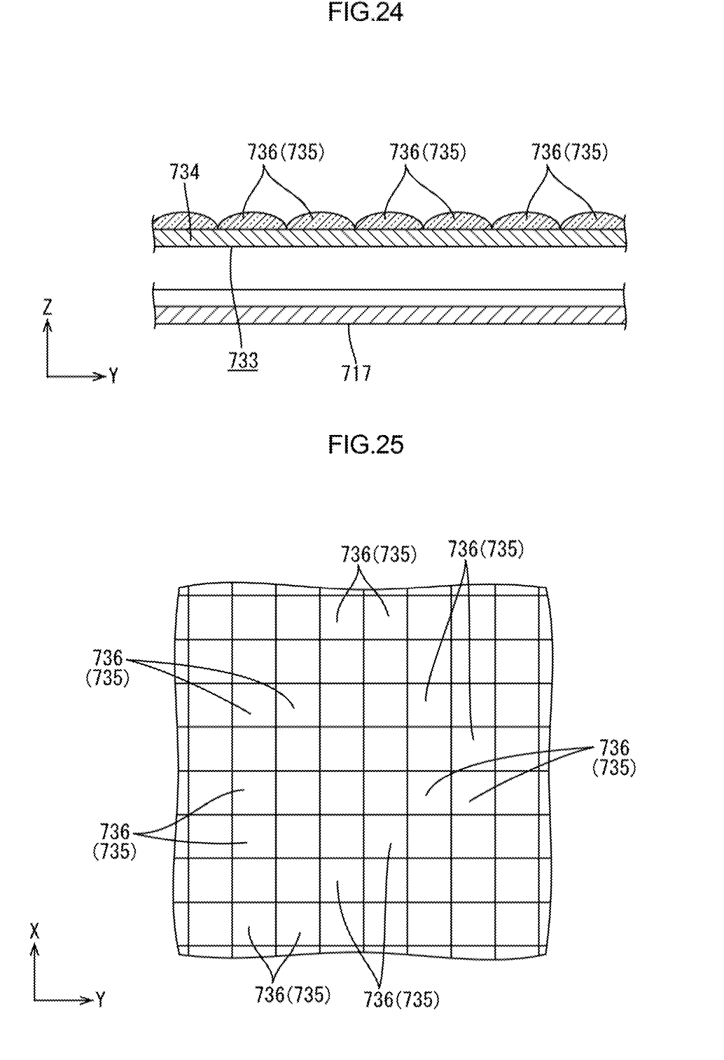

An eighth embodiment according to the present invention is described with reference to FIG. 23 to FIG. 25. The ninth embodiment is different from the above-described fourth embodiment in that an anisotropic microlens sheet 733 has a different configuration. The configuration, operation, and effect similar to those in the above-described fourth embodiment are not described.

As illustrated in FIG. 23 and FIG. 24, the anisotropic microlens sheet 733 included in a projector 711 according to this embodiment includes a sheet base 734 and an anisotropic microlens array 735 on a first planar surface of the sheet base 734, i.e., the planar surface adjacent to the combiner 712. The anisotropic microlens array 735 includes top-displaced microlenses 736 arranged in the X-axis direction and the Y-axis direction in the planar surface of the sheet base 734. The cross-sectional shape of the top-displaced microlens 736 taken in the X-axis direction is aspherical, and a top 736a thereof is displaced toward a first end 736b in the X-axis direction, i.e., toward the side where the optical path length of the projector light is short (see FIG. 23). The cross-sectional shape of the top-displaced cylindrical lens 736 taken in the Y-axis direction is substantially semispherical (see FIG. 24). As illustrated in FIG. 26, the top-displaced microlens 736 does not have a ridge connecting the top 736a with the four corners, and the curvature of the surface continuously changes over the entire area.

As illustrated in FIG. 26, the top-displaced microlenses 736 each have a quadrilateral planar shape (rectangular planar shape) and fill the planar surface of the sheet base 734 with almost no space therebetween. As described above, the top-displaced microlenses 736 included in the anisotropic microlens array 735 each have a quadrilateral planar shape, and thus the exiting light from the top-displaced microlens 736 is anisotropic. Specifically, since the sides shaping the outline of the top-displaced microlens 736 extend in the X-axis direction and the Y-axis direction, the application area of the projector light has a substantially rectangular shape when the exiting light from the top-displaced microlens 736 is projected onto a projection surface 712a of the combiner 712. The application area of the projector light projected onto the projection surface 712a of the combiner 712 is controlled by proper adjustment of the ratio of lengths of the sides of the top-displaced microlens 736 or the lens pitch, enabling the application area of the projector light to have a horizontally elongated rectangular shape corresponding to the visible range (eye box) of the observer. This enables the light to be efficiently collected within the visible range of the observer, providing high light use efficiency.

### Other Embodiments

The present invention is not limited to the embodiments described above with reference to the drawings. For example, the following embodiments are included in the technical scope of the present invention.

(1) In the above-described embodiments, the top-displaced cylindrical lens (top-displaced microlens) has the modified semispherical surface, but may have an ellipsoid, paraboloidal, or hyperboloidal surface, for example.

(2) In the top-displaced cylindrical lens (top-displaced microlens), a specific shape of the surface of the portion from which the projector light is projected toward the side where the optical path length is relatively short, in relation to the central position in the direction, may be suitably changed from those illustrated in the above-described embodiments. The same is applicable to the portion of the top-displaced cylindrical lens (top-displaced microlens) where the projector light is projected toward the side where the optical path length is relatively long, in relation to the central position in the tilting direction.

(3) In the above-described embodiments, the top-displaced cylindrical lens (top-displaced microlens) at least has an aspherical surface at the portion from which the projector light is projected toward the side where the optical path length is relatively short, in relation to the central position in the tilting direction, but the portion may have a spherical surface. It is only required that the portion from which the projector light is projected toward the side where the optical path length is relatively short, in relation to the central position in the tilting direction, and the portion from which the projector light is projected toward the side where the optical path length is relatively long, in relation to the central position in the tilting direction, have different curvatures.

(4) In the above-described embodiments (except for the third, fourth, and eighth embodiments), the cylindrical lenses included in the lenticular lens sheet are arranged perpendicular to each other, but the cylindrical lenses may intersect at an angle other than 90 degrees. The angle of intersection is preferably selected from a range of 45 degrees to 135 degrees, for example.

(5) In the above-described embodiments, the microlenses included in the isotropic microlens array each have a hexagonal planar shape, but may have a polygonal planar shape with five or more sides, such as a pentagonal planar shape and an octagonal planar shape. Alternatively, the microlenses included in the isotropic microlens array each may have a circular planar shape.

(6) In the above-described embodiments, the isotropic microlens array is disposed on the planar surface of the sheet base adjacent to the lenticular lens sheet (anisotropic microlens sheet), but the isotropic microlens array may be disposed on the planar surface of the sheet base remote from the lenticular lens sheet (anisotropic microlens sheet).

(7) The configuration described in any one of the second embodiment to the fourth embodiment or the configuration described in any one of the sixth embodiment to the eighth embodiment may be applied to the configuration of the above-described fifth embodiment.

(8) The configuration described in any one of the second embodiment to the fifth embodiment or the configuration described in the eighth embodiment may be applied to the configuration of the above-described sixth embodiment or the seventh embodiment.

(9) In the above-described sixth embodiment, a light-emitting display device, such as an organic EL panel and a PDP, may be used instead of the liquid crystal display unit.

(10) the above-described third, fourth, and eighth embodiments, the top-displaced microlenses included in the anisotropic microlens array each have a quadrilateral planar shape, but may have another shape such as an elliptical shape.

(11) In the above-described embodiments, the cylindrical lenses (top-displaced microlenses) are disposed on the planar surface of the sheet base over the entire area with almost no space therebetween. However, the sheet base may have a cylindrical-lens-free area where the cylindrical lens (top-displaced microlens) is not disposed.

(12) Other than the above-described embodiments, the present invention is applicable to a configuration in which the projector surface of the screen is tilted in the horizontal direction relative to the projection surface of the combiner.

(13) In the above-described embodiments, the projector includes the isotropic microlens sheet. However, the isotropic microlens sheet may be eliminated.

(14) In the above-described embodiments, the field lens is located closer than the lenticular lens sheet and the anisotropic microlens sheet (lens member), which are included in the screen, to the combiner. However, the filed lens may be located farther than the lenticular lens sheet and the anisotropic microlens sheet (lens member) from the combiner. Alternatively, the field lens may be eliminated.

(15) In the above-described embodiments (except for the seventh embodiment), the laser diode is employed as a light source, but an LED or an organic EL, for example, may be employed. Furthermore, in the above-described seventh embodiment, the light source may be a laser diode or an organic EL.

(16) In the above-described embodiments, the combiner is supported by a sun visor, for example, so as to be located away from the front window, but may be attached to the front window. Alternatively, if the front window is composed of two stacked glasses, the combiner may be sandwiched between two glasses of the front window, for example.

(17) In the above-described embodiments, the projector housed in the dash board is described as an example. However, the projector may be supported by a sun visor or may be hang from a ceiling of an automobile.

(18) In the above-described embodiments, a MEMS mirror device or a DMD display device is employed as the display device of the projector, but an LCOS (Liquid crystal on silicon) may be employed.

(19) In the above-described embodiments, the cholesteric liquid crystal panel employed as the combiner is described as an example, but a holographic element or a half mirror may be employed as the combiner.

(20) In the above-described embodiments, the head-up display mounted in an automobile is described as an example. However, the present invention is applicable to a head-up display to be mounted in other vehicles, such as an airplane, a motorcycle (motorbike), and an amusement ride.

(21) In the above-described embodiments, the head-up display is described as an example. However, the present invention is applicable to a head mounted display.

(22) In the above-described embodiments (except for the seventh embodiment), the MEMS mirror device includes the driver (mirror driver) having two shafts perpendicular to each other, and the two shafts support the mirror. However, the MEMS mirror may include two mirrors, for example, and one of the two shafts perpendicular to each other may support one of the mirrors and the other shaft may support the other mirror. In this configuration, the tilting of each mirror is controlled by each shaft such that light exits toward the screen and two-dimensionally scans the screen. This enables a two-dimensional image to be projected onto the screen. Another modification may be suitably applied to a specific configuration of the MEMS mirror device. The MEMS mirror device described in the first embodiment may be applied to the seventh embodiment in which the light source is an LED. Contrary to that, the DMD display device described in the seventh embodiment may be applied to the first embodiment in which the light source is a laser diode.

### EXPLANATION OF SYMBOLS

10: head-up display (projection type display apparatus), 11, 511, 611, 711: projector, 12, 112, 212, 312, 412, 512, 712: combiner (projection member), 12a, 212a, 412a, 512a, 712a: projection surface, 13: laser diode (light source), 14: MEMS mirror device, 15a, 215a, 415a, 715a: projector surface, 16: field lens, 17, 117, 217, 517, 717: isotropic microlens sheet, 18, 118, 418, 518: lenticular lens sheet (lens member), 21: top-centered microlens, 21a: top, 22, 122: sheet base (base), 23, 123, 423: first lenticular lens portion, 24, 124, 424: second lenticular lens portion, 25, 125, 425, 525: top-displaced cylindrical lens (top-displaced lens), 25a, 425a: top, 25b, 425b: first end (end) 25c, 425c: second end (end), 25d, 425d: portion, 25e, 425e: portion 26, 126, 426: top-centered cylindrical lens, 26a: top, 28: liquid crystal panel (display panel), 29: back light apparatus (lighting apparatus), 30: laser diode (light source), 33, 333, 733: anisotropic microlens sheet (lens member), 35, 335, 735: anisotropic microlens array, 36, 336, 736: top-displaced microlens

1. A projection type display apparatus comprising:
a projector configured to project an image and having a projector surface;
a projection member having a projection surface onto which the image projected by the projector is projected to allow an observer to see a virtual image, the projection surface being tilted relative to the projector surface of the projector; and
a lens member included in the projector, the lens member including a plurality of top-displaced lenses arranged in a tilting direction tilted relative to the projection surface, the top-displaced lenses each including a top displaced such that a brightness peak of projector light to be projected onto the projection surface is shifted, in relation to a central position in the tilting direction, toward a side where an optical path length of the projector light from the projector surface to the projection surface is relatively long.

2. The projection type display apparatus according to claim 1, wherein, in the lens member, the top-displaced lenses each have different curvatures at portions on opposite sides of the top, the portion from which the projector light is projected toward a side where the optical path length is relatively long, in relation to the central position in the tilting direction, has a relatively small curvature and the portion from which the projector light is projected toward a side where the optical path length is relatively short, in relation to the central position in the tilting direction, has a relatively large curvature.

3. The projection type display apparatus according to claim 2, wherein, in the lens member, the portion of each of the top-displaced lenses from which the projector light is projected toward the side where the optical path length is relatively short, in relation to the central position in the tilting direction, has a curvature gradually increasing with distance from the top in the tilting direction.

4. The projection type display apparatus according to claim 1, wherein, in the lens member, the top-displaced lenses each have a convex shape, and the top is displaced toward an end at a side where the optical path length is relatively short, which is one of ends in the tilting direction.

5. The projection type display apparatus according to claim 1, wherein, in the lens member, the top-displaced lenses each have a concave shape, and the top is displaced toward an end at a side where the optical path length is relatively short, which is one of ends in the tilting direction.

6. The projection type display apparatus according to claim 1, wherein the lens member at least includes: a first lenticular lens portion including a plurality of top-displaced cylindrical lenses, as the plurality of top-displaced lenses, extending along the projector surface in a direction intersecting the tilting direction; and a second lenticular lens portion including a plurality of top-centered cylindrical lenses extending in the tilting direction and arranged along the projector surface in a direction perpendicular to the tilting direction, the top-centered cylindrical lenses each having a top at a central position in the tilting direction.

7. The projection type display apparatus according to claim 6, wherein, in the lens member, an extending direction of the plurality of top-displaced cylindrical lenses and an extending direction of the plurality of top-centered cylindrical lenses are perpendicular to each other.

8. The projection type display apparatus according to claim 6, wherein the lens member includes a base having a first planar surface on which the first lenticular lens portion is disposed and a second planar surface on which the second lenticular lens portion is disposed.

9. The projection type display apparatus according to claim 1, wherein the lens member at least includes an anisotropic microlens array from which anisotropic exiting light exits, the anisotropic microlens array including a plurality of top-displaced microlenses, as the plurality of top-displaced lenses, arranged in the tilting direction and in a direction intersecting the tilting direction in a plane of the projector surface, the top-displaced microlenses each having a quadrilateral planar shape.

10. The projection type display apparatus according to claim 1, wherein the projector at least includes the lens member, a MEMS mirror device at least including a mirror configured to reflect light and a mirror driver configured to drive the mirror such that the lens member is scanned by the light reflected by the mirror, and a light source configured to provide light to the MEMS mirror device.

11. The projection type display apparatus according to claim 1, wherein the projector at least includes a display panel and a lighting apparatus configured to apply light to the display panel, the lighting apparatus at least including the lens member and a light source configured to apply light to the lens member.

12. The projection type display apparatus according to claim 1, wherein the projector includes an isotropic microlens array from which isotropic exiting light exits, the isotropic microlens array being located farther than the lens member from the projection member and including the plurality of top-centered microlenses arranged in the tilting direction and in a direction intersecting the tilting direction in a plane of the projector surface, the top-centered microlenses each having a polygonal shape with five or more sides or a circular planar shape and having a top at a central position in the tilting direction.

13. The projection type display apparatus according to claim 1, wherein the projector includes a field lens located closer than the lens member to the projection member.
